(19) United States
(12) Patent Application Publication
(10) Pub. No.: US 2026/0340400 A1
(43) Pub. Date: Oct. 29, 2026

(54) EMULATING CLIMATE DATA USING DIFFUSION MODELS

(71) Applicant: NVIDIA CORPORATION, Santa Clara, CA (US)

(72) Inventors: Akshay SUBRAMANIAM, Campbell, CA (US); Tao GE, Santa Clara, CA (US); Michael Stephen PRITCHARD, Encinitas, CA (US); Aayush GUPTA, Hayward, CA (US); Arash VAHDAT, Santa Mateo, CA (US); Morteza MARDANI, Santa Clara, CA (US); Noah Domino BRENOWITZ, Seattle, WA (US); Peter MANSHAUSEN, Oxford (GB); Karthik KASHINATH, Issaquah, WA (US)

(21) Appl. No.: 19/390,363

(22) Filed: Nov. 14, 2025

Related U.S. Application Data
(60) Provisional application No. 63/796,961, filed on Apr. 29, 2025.

(51) Int. Cl. G06N 3/0895; G06N 3/0464

(52) U.S. Cl. CPC G06N 3/0895; G06N 3/0464

(57) ABSTRACT

The disclosed method for training a diffusion model includes generating, based on conditioning data, one or more conditioning embeddings, generating, based on climate data and mask data, temporal masked climate data, a temporal mask, and one or more channel and temporal masks, adding noise to the temporal masked climate data to generate noisy temporal masked climate data, performing, using the diffusion model, a denoising operation to generate predicted temporal masked climate data based on the one or more conditioning embeddings, the noisy temporal masked climate data, and the temporal mask, calculating a loss based on the one or more channel and temporal masks, the temporal masked climate data, and the predicted temporal masked climate data, and updating, based on the loss, one or more parameters of the diffusion model.

### CROSS-REFERENCE TO RELATED APPLICATIONS

This application claims priority benefit of the United States Provisional Patent Application titled, “TECHNIQUES FOR EMULATING CLIMATE DATA USING CASCADED DIFFUSION MODELS,” filed on Apr. 29, 2025, and having Ser. No. 63/796,961. The subject matter of this related application is hereby incorporated herein by reference.

### BACKGROUND

### Technical Field

Embodiments of the present disclosure relate generally to computer science, artificial intelligence, and machine learning, and more specifically, to techniques for emulating climate data using diffusion models.

### Description of the Related Art

Climate emulation refers to the use of computational algorithms for generating digital representations of climate states, variables, and dynamics across spatial and temporal scales. Climate emulation includes, but is not limited to, reproducing global atmospheric conditions, regional weather phenomena, oceanic processes, or land-atmosphere interactions. Climate emulation can be applied to a wide range of contexts, such as scenario exploration, risk assessment, climate-informed planning, scientific research, educational tools, digital twin simulation, and/or the like. Climate emulation can also be integrated into real-time applications, such as interactive dashboards or decision-support platforms, or used in offline workflows for large-scale modeling, visualization, synthetic data generation, and/or the like.

Conventional approaches for climate emulation typically rely on numerical simulation frameworks and physics-based models to reproduce atmospheric and oceanic states across space and time. In such approaches, the emulation process is typically divided into distinct modules: (i) equation modules for representing governing equations, (ii) discretization modules for discretizing spatial domains, and (iii) temporal integration modules for integrating temporal dynamics. The equation modules define fluid dynamics, radiative transfer, and thermodynamic processes based on physical laws, while discretization modules project the equations onto structured or unstructured computational grids using finite-difference, finite-volume, spectral methods, and/or the like. Temporal integration modules advance the state forward in time by solving coupled differential equations at fixed time steps, often constrained by stability conditions. Conventional approaches also include additional modules, which provide parameterizations for unresolved processes, such as cloud microphysics, turbulent mixing, and/or the like, which are approximated through empirical rules or sub-grid statistical models. For example, conventional approaches for climate emulation can employ large-scale general circulation models (GCMs) to simulate global atmospheric dynamics, while regional climate models (RCMs) refine the dynamics over targeted geographic domains using higher-resolution grids and boundary condition constraints.

One drawback of the above approaches for climate emulation is the reliance on computationally intensive numerical solvers and parameterized sub-grid processes, which limit scalability and accessibility for interactive or large-scale applications. In practice, reproducing global climate dynamics at high spatial and temporal resolution requires massive computational resources and extended runtimes, often making conventional approaches unsuitable for rapid scenario testing or real-time interactivity. For example, generating kilometer-scale climate projections over long time horizons can demand allocations on supercomputing clusters and consume significant energy budgets, while regional downscaling experiments can still take days or weeks to complete depending on the chosen resolution and domain size.

Another drawback of the above approaches is climate emulation systems that depend on rigid discretization schemes and empirical parameterizations oftentimes require calibration or tuning to capture diverse climate regimes and remain constrained by numerical stability conditions, making the conventional climate emulation approaches less adaptable to exploratory applications or user-driven simulation workflows.

Yet another drawback of the above approaches is the difficulty of handling heterogeneous and incomplete datasets, which are common in climate science. Different observational records and simulation products often provide overlapping but non-identical variables, operate at different spatial or temporal resolutions, or employ distinct grid structures that are not directly aligned. In many cases, certain variables could be missing altogether, or data could be sparsely sampled due to measurement gaps or limited model outputs. The inconsistencies make the unification of diverse climate datasets into a single modeling framework challenging, and conventional emulation approaches often require extensive preprocessing, interpolation, or manual harmonization.

As the foregoing illustrates, what is needed in the art are more effective techniques for climate emulation.

### SUMMARY

According to some embodiments, a computer-implemented method for training a diffusion model includes generating, based on conditioning data, one or more conditioning embeddings. The method also includes generating, based on climate data and mask data, masked climate data. The method further includes adding noise to the masked climate data to generate noisy masked climate data. Furthermore, the method includes performing, using the diffusion model, a denoising step to generate predicted masked climate data based on the one or more conditioning embeddings and the noisy masked climate data. Additionally, the method includes calculating a loss based on the mask data, the masked climate data, and the predicted masked climate data. In addition, the method includes updating, based on the loss, one or more parameters of the diffusion model.

According to some embodiments, a computer-implemented method for training a diffusion model includes generating, based on conditioning data, one or more conditioning embeddings. The method also includes generating, based on climate data and mask data, temporal masked climate data, a temporal mask, and one or more channel and temporal masks. The method further includes adding noise to the temporal masked climate data to generate noisy temporal masked climate data. Additionally, the method includes performing, using the diffusion model, a denoising operation to generate predicted temporal masked climate data based on the one or more conditioning embeddings, the noisy temporal masked climate data, and the temporal mask. In addition, the method includes calculating a loss based on the one or more channel and temporal masks, the temporal masked climate data, and the predicted temporal masked climate data. Furthermore, the method includes updating, based on the loss, one or more parameters of the diffusion model.

According to some embodiments, a computer-implemented method for generating output climate data includes receiving a user control input, input climate data, input conditioning data, and input mask data. The method also includes generating, based on the user control input, an inference strategy. The method further includes performing, using at least one of a first diffusion model, a second diffusion model, or a third diffusion model, one or more reverse diffusion operations to generate the output climate data based on the inference strategy, the input climate data, the input conditioning data, and the input mask data.

Further embodiments provide, among other things, non-transitory computer-readable storage media storing instructions and systems configured to implement the method set forth above.

At least one technical advantage of the disclosed techniques relative to the prior art is that the disclosed techniques eliminate the need for computationally intensive numerical solvers and parameterized sub-grid process approximations by directly learning from observational and simulation data, thereby enabling kilometer-scale global field generation with significantly reduced computational cost and runtime. Another technical advantage is that the disclosed techniques relax rigid discretization schemes and stability-constrained integration steps, which allow the models to adapt to diverse climate regimes without manual calibration or tuning. A further technical advantage is that the disclosed techniques support heterogeneous and incomplete datasets, permitting the incorporation of non-aligned grids, partially missing channels, or sparsely sampled records into a single generative model without requiring exhaustive preprocessing or harmonization. These technical advantages provide one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, can be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 is a block diagram of a computer system configured to implement one or more aspects of the present disclosure;

FIG. 2 is a block diagram of a parallel processing unit included in the parallel processing subsystem of FIG. 1, according to various embodiments of the present disclosure; and

FIG. 3 is a block diagram of a general processing cluster included in the parallel processing unit of FIG. 2, according to various embodiments of the present disclosure.

FIG. 4 is a block diagram of a computer-based system configured to implement one or more aspects of various embodiments;

FIG. 5 illustrates how the model trainer of FIG. 1 trains the coarse diffusion model of FIG. 4, according to various embodiments;

FIG. 6 illustrates how the model trainer of FIG. 1 trains the video diffusion model of FIG. 4, according to various embodiments;

FIG. 7 illustrates how the model trainer of FIG. 4 trains the super-resolution diffusion model of FIG. 1, according to various embodiments;

FIG. 8 is a more detailed illustration of the climate emulation application of FIG. 1, according to various embodiments;

FIG. 9 is a flow diagram of method steps for training the coarse diffusion model, the video diffusion model, and the super-resolution diffusion model, according to various embodiments;

FIG. 10 is a flow diagram of method steps for training the coarse diffusion model, according to various embodiments;

FIG. 11 is a flow diagram of method steps for training the video diffusion model, according to various embodiments;

FIG. 12 is a flow diagram of method steps for training the super-resolution diffusion model, according to various embodiments; and

FIG. 13 is a flow diagram of method steps for generating output climate data, according to various embodiments

### DETAILED DESCRIPTION

In the following description, numerous specific details are set forth to provide a more thorough understanding of the various embodiments. However, it will be apparent to one skilled in the art that the concepts can be practiced without one or more of these specific details.

### General Overview

Embodiments of the present disclosure provide techniques for climate emulation using diffusion models. The disclosed techniques include a coarse diffusion model, a video diffusion model, and a super-resolution diffusion model. The coarse diffusion model is a machine learning model, such as a neural network, which processes one or more first conditioning embeddings and generates predicted masked climate data. The video diffusion model is another machine learning model, such as neural network, which processes the first conditioning embeddings and a temporal mask and generates predicted temporal masked climate data. The super-resolution diffusion model is yet another machine learning model, such as a neural network, which processes one or more second conditional embeddings and generates predicted patched high-resolution climate data. In some embodiments, during training of the coarse diffusion model, a conditioning embedder processes conditioning data included in the training data and generates the first conditioning embeddings. A masking module processes climate data and mask data included in the training data and generates masked climate data. A noise adder adds noise to the masked climate data to generate noisy masked climate data. The coarse diffusion model performs a denoising step to generate the predicted masked climate data based on the first conditioning embeddings and the noisy masked climate data. A loss calculator calculates a first loss based on the predicted masked climate data, the masked climate data, and the mask data. The model trainer updates the one or more parameters of the coarse diffusion model based on the first loss.

In some embodiments, during the training of the video diffusion model, the conditioning embedder processes the conditioning data and generates the first conditioning embedding. A temporal masking module processes the mask data and the climate data and generates temporal masked climate data, a temporal mask, and one or more channel and temporal masks. The noise adder adds noise to the temporal masked climate data and generates noisy temporal masked climate data. The video diffusion model performs a denoising diffusion step to generate predicted temporal masked climate data based on the first conditioning embeddings, the temporal mask, and the noisy temporal masked climate data. The loss calculator calculates a second loss based on predicted temporal masked climate data, the temporal masked climate data, and the channel and temporal masks. The model trainer updates the parameters of the video diffusion model based on the second loss.

In some embodiments, during the training of the super-resolution diffusion model, a patching module processes high-resolution climate data included in the training data and generates one or more patch identifiers and patched high-resolution climate data. The conditioning embedder processes the patch identifiers and coarse climate data included in the conditioning data and generates the second conditioning embeddings. The noise adder adds noise to the patched high-resolution climate data and generates noisy patched high-resolution climate data. The super-resolution diffusion model performs a denoising step to generate predicted patched high-resolution climate data based on the second conditioning embeddings and the noisy patched high-resolution climate data. The loss calculator calculates a third loss based on the patched high-resolution climate data and the predicted patched high-resolution climate data. The model trainer updates the one or more parameters of super-resolution diffusion model based on the third loss. In some embodiments, once training is complete, a climate emulation application uses the trained coarse diffusion model, the trained video diffusion model, and the trained super-resolution model to process a user control input, input climate data, input conditioning data, input mask data and optionally input patch data and generate output climate data. The climate emulation application selects an inference strategy based on the user control input. In some embodiments, the climate emulation application includes a multi-diffusion inference module that performs one or more reverse diffusion steps, using at least one of the trained coarse diffusion model, the trained video diffusion model, and the trained super-resolution model, to generate the output climate data based on the inference strategy, the input climate data, the input conditioning data, the input mask data and optionally the input patch data.

The climate emulation techniques of the present disclosure have many real-world applications. For example, the climate emulation techniques could be used to generate global or regional atmospheric states for use in interactive dashboards, climate risk assessment platforms, or decision-support systems. As another example, the techniques could be applied to produce high-resolution spatiotemporal fields, such as temperature, precipitation, or wind patterns, for use in scientific visualization, educational tools, or immersive simulation environments. In further examples, the techniques could be leveraged to construct digital climate twins for scenario exploration, policy evaluation, or proactive resource planning across domains such as agriculture, energy, transportation, and disaster preparedness.

The above examples are not in any way intended to be limiting. As persons skilled in the art will appreciate, as a general matter, the robot control techniques described herein can be implemented in any suitable application.

### System Overview

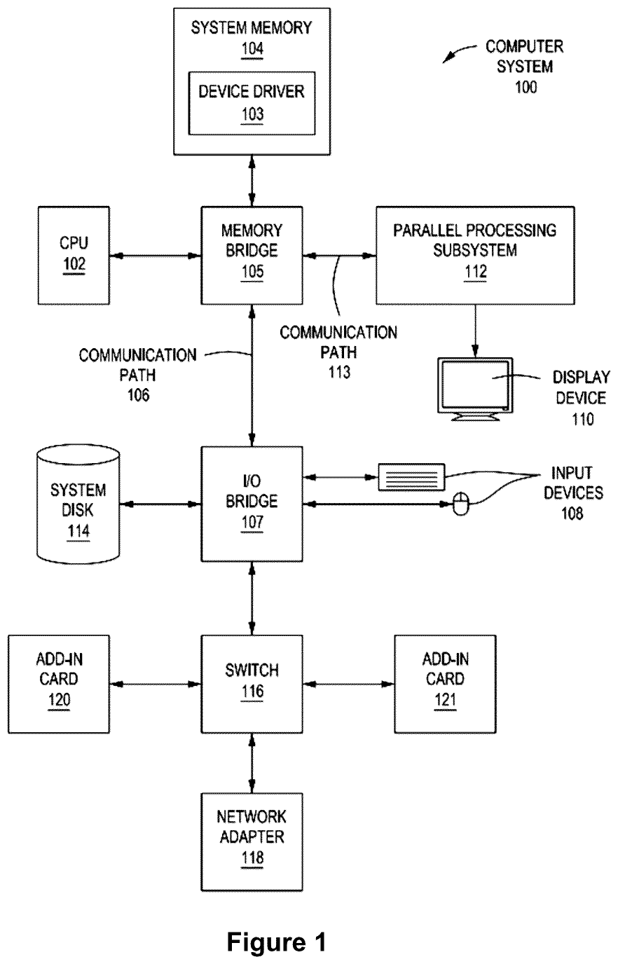

FIG. 1 is a block diagram of a computer system 100 configured to implement one or more aspects of the present disclosure. As shown, computer system 100 includes, without limitation, a central processing unit (CPU) 102 and a system memory 104 coupled to a parallel processing subsystem 112 via a memory bridge 105 and a communication path 113. Memory bridge 105 is further coupled to an I/O (input/output) bridge 107 via a communication path 106, and I/O bridge 107 is, in turn, coupled to a switch 116. As persons skilled in the art will appreciate, computer system 100 can be any type of technically feasible computer system, including, without limitation, a server machine, a server platform, a desktop machine, laptop machine, or a hand-held/mobile device. Persons skilled in the art also will appreciate that computer system 100 or systems similar to computer system 100 can be incorporated into a vehicle or machine to facilitate driving, steering, or otherwise controlling that vehicle or machine, as the case may be.

In operation, I/O bridge 107 is configured to receive user input information from input devices 108, such as a keyboard or a mouse, and forward the input information to CPU 102 for processing via communication path 106 and memory bridge 105. Switch 116 is configured to provide connections between I/O bridge 107 and other components of the computer system 100, such as a network adapter 118 and various add-in cards 120 and 121.

As also shown, I/O bridge 107 is coupled to a system disk 114 that may be configured to store content and applications and data for use by CPU 102 and parallel processing subsystem 112. As a general matter, system disk 114 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high definition DVD), or other magnetic, optical, or solid state storage devices. Finally, although not explicitly shown, other components, such as universal serial bus or other port connections, compact disc drives, digital versatile disc drives, film recording devices, and the like, may be connected to I/O bridge 107 as well.

In various embodiments, memory bridge 105 may be a Northbridge chip, and I/O bridge 107 may be a Southbrige chip. In addition, communication paths 106 and 113, as well as other communication paths within computer system 100, may be implemented using any technically suitable protocols, including, without limitation, AGP (Accelerated Graphics Port), HyperTransport, or any other bus or point-to-point communication protocol known in the art.

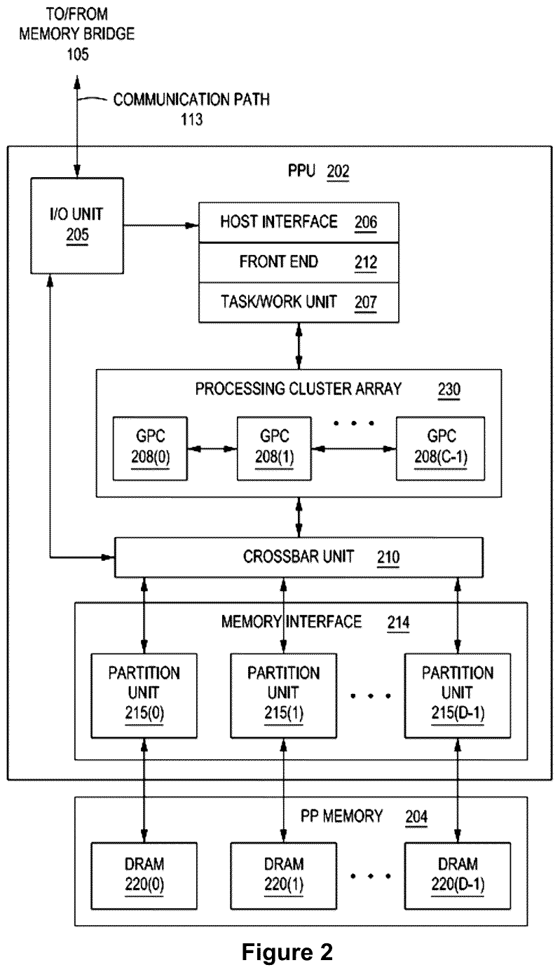

In some embodiments, parallel processing subsystem 112 comprises a graphics subsystem that delivers pixels to a display device 110 that may be any conventional cathode ray tube, liquid crystal display, light-emitting diode display, or the like. In such embodiments, the parallel processing subsystem 112 incorporates circuitry optimized for graphics and video processing, including, for example, video output circuitry. As described in greater detail below in FIG. 2, such circuitry may be incorporated across one or more parallel processing units (PPUs) included within parallel processing subsystem 112. In other embodiments, the parallel processing subsystem 112 incorporates circuitry optimized for general purpose and/or compute processing. Again, such circuitry may be incorporated across one or more PPUs included within parallel processing subsystem 112 that are configured to perform such general purpose and/or compute operations. In yet other embodiments, the one or more PPUs included within parallel processing subsystem 112 may be configured to perform graphics processing, general purpose processing, and compute processing operations. System memory 104 includes at least one device driver 103 configured to manage the processing operations of the one or more PPUs within parallel processing subsystem 112.

In various embodiments, parallel processing subsystem 112 may be integrated with one or more other the other elements of FIG. 1 to form a single system. For example, parallel processing subsystem 112 may be integrated with CPU 102 and other connection circuitry on a single chip to form a system on chip (SoC).

It will be appreciated that the system shown herein is illustrative and that variations and modifications are possible. The connection topology, including the number and arrangement of bridges, the number of CPUs 102, and the number of parallel processing subsystems 112, may be modified as desired. For example, in some embodiments, system memory 104 could be connected to CPU 102 directly rather than through memory bridge 105, and other devices would communicate with system memory 104 via memory bridge 105 and CPU 102. In other alternative topologies, parallel processing subsystem 112 may be connected to I/O bridge 107 or directly to CPU 102, rather than to memory bridge 105. In still other embodiments, I/O bridge 107 and memory bridge 105 may be integrated into a single chip instead of existing as one or more discrete devices. Lastly, in certain embodiments, one or more components shown in FIG. 1 may not be present. For example, switch 116 could be eliminated, and network adapter 118 and add-in cards 120, 121 would connect directly to I/O bridge 107.

FIG. 2 is a block diagram of a parallel processing unit (PPU) 202 included in the parallel processing subsystem 112 of FIG. 1, according to various embodiments of the present disclosure. Although FIG. 2 depicts one PPU 202, as indicated above, parallel processing subsystem 112 may include any number of PPUs 202. As shown, PPU 202 is coupled to a local parallel processing (PP) memory 204. PPU 202 and PP memory 204 may be implemented using one or more integrated circuit devices, such as programmable processors, application specific integrated circuits (ASICs), or memory devices, or in any other technically feasible fashion.

In some embodiments, PPU 202 comprises a graphics processing unit (GPU) that may be configured to implement a graphics rendering pipeline to perform various operations related to generating pixel data based on graphics data supplied by CPU 102 and/or system memory 104. When processing graphics data, PP memory 204 can be used as graphics memory that stores one or more conventional frame buffers and, if needed, one or more other render targets as well. Among other things, PP memory 204 may be used to store and update pixel data and deliver final pixel data or display frames to display device 110 for display. In some embodiments, PPU 202 also may be configured for general-purpose processing and compute operations.

In operation, CPU 102 is the master processor of computer system 100, controlling and coordinating operations of other system components. In particular, CPU 102 issues commands that control the operation of PPU 202. In some embodiments, CPU 102 writes a stream of commands for PPU 202 to a data structure (not explicitly shown in either FIG. 1 or FIG. 2) that may be located in system memory 104, PP memory 204, or another storage location accessible to both CPU 102 and PPU 202. A pointer to the data structure is written to a pushbuffer to initiate processing of the stream of commands in the data structure. The PPU 202 reads command streams from the pushbuffer and then executes commands asynchronously relative to the operation of CPU 102. In embodiments where multiple pushbuffers are generated, execution priorities may be specified for each pushbuffer by an application program via device driver 103 to control scheduling of the different pushbuffers.

As also shown, PPU 202 includes an I/O (input/output) unit 205 that communicates with the rest of computer system 100 via the communication path 113 and memory bridge 105. I/O unit 205 generates packets (or other signals) for transmission on communication path 113 and also receives all incoming packets (or other signals) from communication path 113, directing the incoming packets to appropriate components of PPU 202. For example, commands related to processing tasks may be directed to a host interface 206, while commands related to memory operations (e.g., reading from or writing to PP memory 204) may be directed to a crossbar unit 210. Host interface 206 reads each pushbuffer and transmits the command stream stored in the pushbuffer to a front end 212.

As mentioned above in conjunction with FIG. 1, the connection of PPU 202 to the rest of computer system 100 may be varied. In some embodiments, parallel processing subsystem 112, which includes at least one PPU 202, is implemented as an add-in card that can be inserted into an expansion slot of computer system 100. In other embodiments, PPU 202 can be integrated on a single chip with a bus bridge, such as memory bridge 105 or I/O bridge 107. Again, in still other embodiments, some or all of the elements of PPU 202 may be included along with CPU 102 in a single integrated circuit or system of chip (SoC).

In operation, front end 212 transmits processing tasks received from host interface 206 to a work distribution unit (not shown) within task/work unit 207. The work distribution unit receives pointers to processing tasks that are encoded as task metadata (TMD) and stored in memory. The pointers to TMDs are included in a command stream that is stored as a pushbuffer and received by the front end unit 212 from the host interface 206. Processing tasks that may be encoded as TMDs include indices associated with the data to be processed as well as state parameters and commands that define how the data is to be processed. For example, the state parameters and commands could define the program to be executed on the data. The task/work unit 207 receives tasks from the front end 212 and ensures that GPCs 208 are configured to a valid state before the processing task specified by each one of the TMDs is initiated. A priority may be specified for each TMD that is used to schedule the execution of the processing task. Processing tasks also may be received from the processing cluster array 230. Optionally, the TMD may include a parameter that controls whether the TMD is added to the head or the tail of a list of processing tasks (or to a list of pointers to the processing tasks), thereby providing another level of control over execution priority.

PPU 202 advantageously implements a highly parallel processing architecture based on a processing cluster array 230 that includes a set of C general processing clusters (GPCs) 208, where CD 1. Each GPC 208 is capable of executing a large number (e.g., hundreds or thousands) of threads concurrently, where each thread is an instance of a program. In various applications, different GPCs 208 may be allocated for processing different types of programs or for performing different types of computations. The allocation of GPCs 208 may vary depending on the workload arising for each type of program or computation.

Memory interface 214 includes a set of D of partition units 215, where D □ 1. Each partition unit 215 is coupled to one or more dynamic random access memories (DRAMs) 220 residing within PPM memory 204. In one embodiment, the number of partition units 215 equals the number of DRAMs 220, and each partition unit 215 is coupled to a different DRAM 220. In other embodiments, the number of partition units 215 may be different than the number of DRAMs 220. Persons of ordinary skill in the art will appreciate that a DRAM 220 may be replaced with any other technically suitable storage device. In operation, various render targets, such as texture maps and frame buffers, may be stored across DRAMs 220, allowing partition units 215 to write portions of each render target in parallel to efficiently use the available bandwidth of PP memory 204.

A given GPCs 208 may process data to be written to any of the DRAMs 220 within PP memory 204. Crossbar unit 210 is configured to route the output of each GPC 208 to the input of any partition unit 215 or to any other GPC 208 for further processing. GPCs 208 communicate with memory interface 214 via crossbar unit 210 to read from or write to various DRAMs 220. In one embodiment, crossbar unit 210 has a connection to I/O unit 205, in addition to a connection to PP memory 204 via memory interface 214, thereby enabling the processing cores within the different GPCs 208 to communicate with system memory 104 or other memory not local to PPU 202. In the embodiment of FIG. 2, crossbar unit 210 is directly connected with I/O unit 205. In various embodiments, crossbar unit 210 may use virtual channels to separate traffic streams between the GPCs 208 and partition units 215.

Again, GPCs 208 can be programmed to execute processing tasks relating to a wide variety of applications, including, without limitation, linear and nonlinear data transforms, filtering of video and/or audio data, modeling operations (e.g., applying laws of physics to determine position, velocity and other attributes of objects), image rendering operations (e.g., tessellation shader, vertex shader, geometry shader, and/or pixel/fragment shader programs), general compute operations, etc. In operation, PPU 202 is configured to transfer data from system memory 104 and/or PP memory 204 to one or more on-chip memory units, process the data, and write result data back to system memory 104 and/or PP memory 204. The result data may then be accessed by other system components, including CPU 102, another PPU 202 within parallel processing subsystem 112, or another parallel processing subsystem 112 within computer system 100.

As noted above, any number of PPUs 202 may be included in a parallel processing subsystem 112. For example, multiple PPUs 202 may be provided on a single add-in card, or multiple add-in cards may be connected to communication path 113, or one or more of PPUs 202 may be integrated into a bridge chip. PPUs 202 in a multi-PPU system may be identical to or different from one another. For example, different PPUs 202 might have different numbers of processing cores and/or different amounts of PP memory 204. In implementations where multiple PPUs 202 are present, those PPUs may be operated in parallel to process data at a higher throughput than is possible with a single PPU 202. Systems incorporating one or more PPUs 202 may be implemented in a variety of configurations and form factors, including, without limitation, desktops, laptops, handheld personal computers or other handheld devices, servers, workstations, game consoles, embedded systems, and the like.

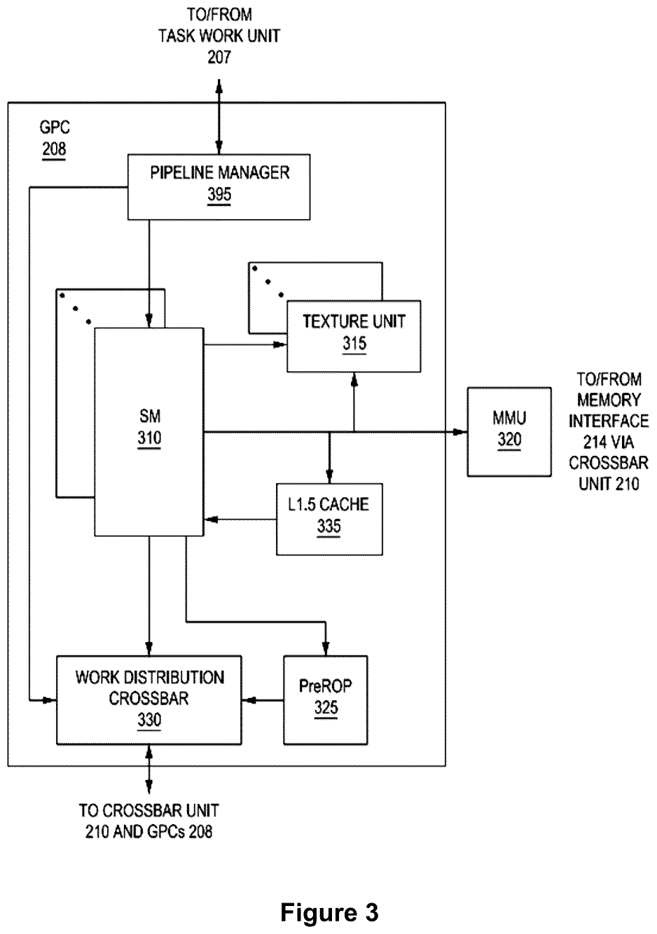

FIG. 3 is a block diagram of a GPC 208 included in PPU 202 of FIG. 2, according to various embodiments of the present disclosure. In operation, GPC 208 may be configured to execute a large number of threads in parallel to perform graphics, general processing and/or compute operations. As used herein, a “thread” refers to an instance of a particular program executing on a particular set of input data. In some embodiments, single-instruction, multiple-data (SIMD) instruction issue techniques are used to support parallel execution of a large number of threads without providing multiple independent instruction units. In other embodiments, single-instruction, multiple-thread (SIMT) techniques are used to support parallel execution of a large number of generally synchronized threads, using a common instruction unit configured to issue instructions to a set of processing engines within GPC 208. Unlike a SIMD execution regime, where all processing engines typically execute identical instructions, SIMT execution allows different threads to more readily follow divergent execution paths through a given program. Persons of ordinary skill in the art will understand that a SIMD processing regime represents a functional subset of a SIMT processing regime.

Operation of GPC 208 is controlled via a pipeline manager 305 that distributes processing tasks received from a work distribution unit (not shown) within task/work unit 207 to one or more streaming multiprocessors (SMs) 310. Pipeline manager 305 may also be configured to control a work distribution crossbar 330 by specifying destinations for processed data output by SMs 310.

In one embodiment, GPC 208 includes a set of M of SMs 310, where M≥1. Also, each SM 310 includes a set of functional execution units (not shown), such as execution units and load-store units. Processing operations specific to any of the functional execution units may be pipelined, which enables a new instruction to be issued for execution before a previous instruction has completed execution. Any combination of functional execution units within a given SM 310 may be provided. In various embodiments, the functional execution units may be configured to support a variety of different operations including integer and floating point arithmetic (e.g., addition and multiplication), comparison operations, Boolean operations (AND, OR, XOR), bit-shifting, and computation of various algebraic functions (e.g., planar interpolation and trigonometric, exponential, and logarithmic functions, etc.). Advantageously, the same functional execution unit can be configured to perform different operations.

In operation, each SM 310 is configured to process one or more thread groups. As used herein, a “thread group” or “warp” refers to a group of threads concurrently executing the same program on different input data, with one thread of the group being assigned to a different execution unit within an SM 310. A thread group may include fewer threads than the number of execution units within the SM 310, in which case some of the execution may be idle during cycles when that thread group is being processed. A thread group may also include more threads than the number of execution units within the SM 310, in which case processing may occur over consecutive clock cycles. Since each SM 310 can support up to G thread groups concurrently, it follows that up to G*M thread groups can be executing in GPC 208 at any given time.

Additionally, a plurality of related thread groups may be active (in different phases of execution) at the same time within an SM 310. This collection of thread groups is referred to herein as a “cooperative thread array” (“CTA”) or “thread array.” The size of a particular CTA is equal to m*k, where k is the number of concurrently executing threads in a thread group, which is typically an integer multiple of the number of execution units within the SM 310, and m is the number of thread groups simultaneously active within the SM 310.

Although not shown in FIG. 3, each SM 310 contains a level one (L1) cache or uses space in a corresponding L1 cache outside of the SM 310 to support, among other things, load and store operations performed by the execution units. Each SM 310 also has access to level two (L2) caches (not shown) that are shared among all GPCs 208 in PPU 202. The L2 caches may be used to transfer data between threads. Finally, SMs 310 also have access to off-chip “global” memory, which may include PP memory 204 and/or system memory 104. It is to be understood that any memory external to PPU 202 may be used as global memory. Additionally, as shown in FIG. 3, a level one-point-five (L1.5) cache 335 may be included within GPC 208 and configured to receive and hold data requested from memory via memory interface 214 by SM 310. Such data may include, without limitation, instructions, uniform data, and constant data. In embodiments having multiple SMs 310 within GPC 208, the SMs 310 may beneficially share common instructions and data cached in L1.5 cache 335.

Each GPC 208 may have an associated memory management unit (MMU) 320 that is configured to map virtual addresses into physical addresses. In various embodiments, MMU 320 may reside either within GPC 208 or within the memory interface 214. The MMU 320 includes a set of page table entries (PTEs) used to map a virtual address to a physical address of a tile or memory page and optionally a cache line index. The MMU 320 may include address translation lookaside buffers (TLB) or caches that may reside within SMs 310, within one or more L1 caches, or within GPC 208.

In graphics and compute applications, GPC 208 may be configured such that each SM 310 is coupled to a texture unit 315 for performing texture mapping operations, such as determining texture sample positions, reading texture data, and filtering texture data.

In operation, each SM 310 transmits a processed task to work distribution crossbar 330 in order to provide the processed task to another GPC 208 for further processing or to store the processed task in an L2 cache (not shown), parallel processing memory 204, or system memory 104 via crossbar unit 210. In addition, a pre-raster operations (preROP) unit 325 is configured to receive data from SM 310, direct data to one or more raster operations (ROP) units within partition units 215, perform optimizations for color blending, organize pixel color data, and perform address translations.

It will be appreciated that the core architecture described herein is illustrative and that variations and modifications are possible. Among other things, any number of processing units, such as SMs 310, texture units 315, or preROP units 325, may be included within GPC 208. Further, as described above in conjunction with FIG. 2, PPU 202 may include any number of GPCs 208 that are configured to be functionally similar to one another so that execution behavior does not depend on which GPC 208 receives a particular processing task. Further, each GPC 208 operates independently of the other GPCs 208 in PPU 202 to execute tasks for one or more application programs. In view of the foregoing, persons of ordinary skill in the art will appreciate that the architecture described in FIGS. 1-3 in no way limits the scope of the present disclosure.

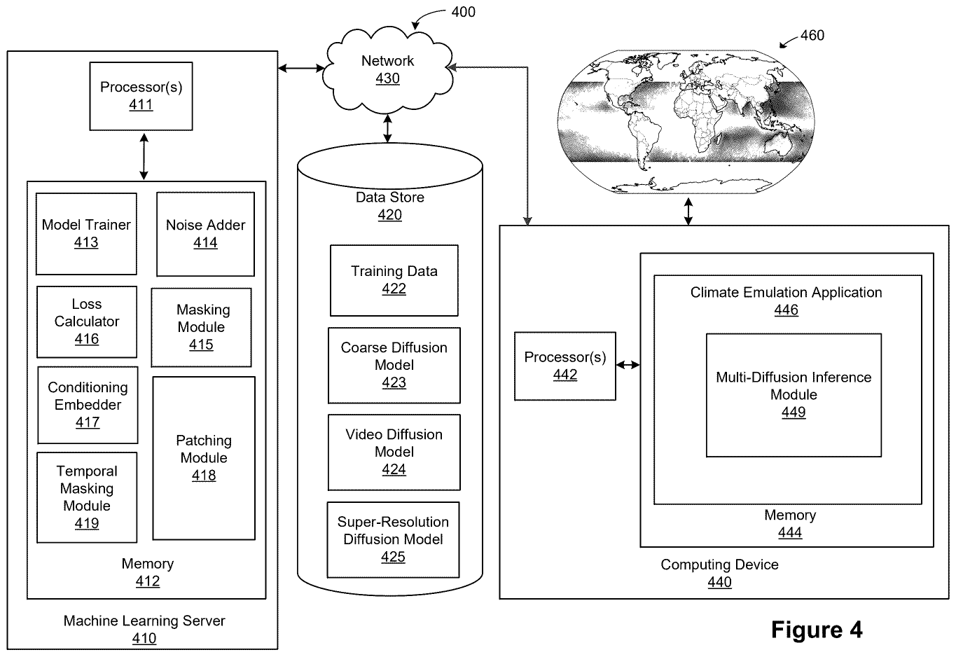

FIG. 4 is a block diagram of a computer-based system configured to implement one or more aspects of various embodiments. As shown, system 400 includes a machine learning server 410, a data store 420, and a computing device 440 in communication over a network 430, which can be a wide area network (WAN) such as the Internet, a local area network (LAN), a cellular network, and/or any other suitable network. Machine learning server 410 includes, without limitation, processor(s) 411 and a memory 412. Memory 412 includes, without limitation, a model trainer 413, a noise adder 414, a masking module 415, a loss calculator 416, a conditioning embedder 417, a patching module 418, and a temporal masking module 419. Data store 420 includes, without limitation, training data 422, a coarse diffusion model 423, a video diffusion model 424, and a super-resolution diffusion model 425. Computing device 440 includes, without limitation, processor(s) 442 and a memory 444. Memory 444 includes, without limitation, a climate emulation application 446. Climate emulation application 446 includes, without limitation, a multi-diffusion inference module 449.

Processor(s) 411 receive user input from input devices, such as a keyboard or a mouse. Processor(s) 411 may include one or more primary processors of machine learning server 410, controlling and coordinating operations of other system components. In particular, processor(s) 411 can issue commands that control the operation of one or more graphics processing units (GPUs) (not shown) and/or other parallel processing circuitry (e.g., parallel processing units, deep learning accelerators, etc.) that incorporates circuitry optimized for graphics and video processing, including, for example, video output circuitry. The GPU(s) can deliver pixels to a display device that can be any conventional cathode ray tube, liquid crystal display, light-emitting diode display, and/or the like.

Memory 412 of machine learning server 410 stores content, such as software applications and data, for use by processor(s) 411 and the GPU(s) and/or other processing units. Memory 412 can be any type of memory capable of storing data and software applications, such as a random-access memory (RAM), a read-only memory (ROM), an erasable programmable read-only memory (EPROM or Flash ROM), or any suitable combination of the foregoing. In some embodiments, a storage (not shown) can supplement or replace the memory 412. The storage can include any number and type of external memories that are accessible to processor 411 and/or the GPU. For example, and without limitation, the storage can include a Secure Digital Card, an external Flash memory, a portable compact disc read-only memory (CD-ROM), an optical storage device, a magnetic storage device, and/or any suitable combination of the foregoing.

Machine learning server 410 shown herein is for illustrative purposes only, and variations and modifications are possible without departing from the scope of the present disclosure. For example, the number of processors 411, the number of GPUs and/or other processing unit types, the number of memories 412, and/or the number of applications included in memory 412 can be modified as desired. Further, the connection topology between the various units in FIG. 4 can be modified as desired. In some embodiments, any combination of processor(s) 411, memory 412, and/or GPU(s) can be included in and/or replaced with any type of virtual computing system, distributed computing system, and/or cloud computing environment, such as a public, private, or a hybrid cloud system.

As shown, noise adder 414 is an application that executes on one or more processors 411 of machine learning server 410 and is stored in memory 412 of machine learning server 410. In some embodiments, noise adder 414 adds noise to input data to generate noisy input data. In some embodiments, noise adder 414 includes a noise scheduler that defines how noise levels are distributed across one or more denoising steps. In some embodiments, noise adder 414 specifies a sequence of variances or standard deviations applied to the input data, such as a log-uniform schedule when the input data includes masked climate data or temporal masked climate data, or a log-normal schedule when the input data includes patched high-resolution climate data. In some embodiments, the noise scheduler is configured to emphasize certain scales of variation, prevent signal leakage from dominant seasonal or diurnal modes, or stabilize the training of high-frequency details. In some embodiments, noise adder 414 samples a noise value from the noise scheduler for each training step and perturbs the input data with Gaussian-distributed random noise at that level.

Conditioning embedder 417 is an application that executes on one or more processors 411 of machine learning server 410 and is stored in memory 412 of machine learning server 410. Conditioning embedder 417 processes conditioning data included in training data 422 and optionally one or more patch identifiers and generates one or more conditioning embeddings.

Training data 422 stored in data store 420 includes, without limitation, the conditioning data, climate data, and mask data. The climate data includes, without limitation, high-resolution atmospheric state variables (e.g., high-resolution climate data), such as temperature, wind, humidity, or precipitation, represented on a spherical grid, as well as corresponding coarse-resolution fields derived from reanalysis or downsampled simulations, such as the European Centre for Medium-Range Weather Forecasts (ECMWF) Reanalysis version 5 (ERA5) dataset at approximately 25 kilometer resolution and the ICOsahedral Nonhydrostatic (ICON) Cycle 3 simulation data at approximately 5 kilometer resolution, each interpolated to a Hierarchical Equal Area isoLatitude Pixelization (HEALPix, HPX) spherical grid at varying resolutions. The conditioning data includes, without limitation, auxiliary inputs, such as sea surface temperature (SST) fields, calendar information, dataset class identifiers, coarse climate data, and/or the like, such as Atmospheric Model Intercomparison Project (AMIP) monthly SST forcing interpolated to HPX64 resolution for ERA5 or smoothed into rolling 30-day averages for ICON. The mask data includes, without limitation, channel masks that indicate which atmospheric variables are observed or missing, temporal masks that indicate which frames in a sequence are visible, and spatial masks that indicate which regions are subject to clamping or steering constraints. In some embodiments, training data 422 further includes metadata describing data provenance, grid resolution, or sampling parameters, which can be used to harmonize heterogeneous datasets within a single training pipeline.

Masking module 415 is an application that executes on one or more processors 411 of machine learning server 410 and is stored in memory 412 of machine learning server 410. Masking module 415 processes the climate data and the mask data and generates the masked climate data. In some embodiments, masking module 415 applies channel masks included in the mask data to zero out or otherwise replace values for unobserved atmospheric variables included in the climate data while preserving values for observed variables. In some embodiments, masking module 415 uses spatial masks included in the mask data to restrict visibility to specified regions of a spherical grid, such as a HEALPix or HPX grid, which permits training on partial climate data or guidance by region-specific inputs.

Temporal masking module 419 is an application that executes on one or more processors 411 of machine learning server 410 and is stored in memory 412 of machine learning server 410. Temporal masking module 419 processes the climate data and the mask data and generates a temporal mask, temporal masked climate data, and one or more channel and temporal masks. In some embodiments, temporal masking module 419 applies temporal masks included in the mask data to designate which frames in a sequence of the climate data are visible for video diffusion model 424 during training. By selectively withholding certain frames, temporal masking module 419 enables video diffusion model 424 to learn to propagate dynamics across missing intervals and improves the ability to reconstruct physically consistent sequences. In some embodiments, temporal masking module 419 further combines temporal masks with channel masks included in the mask data to create the channel and temporal masks, allowing video diffusion model 424 to simulate scenarios where certain variables are missing for specific time steps.

Patching module 418 is an application that executes on one or more processors 411 of machine learning server 410 and is stored in memory 412 of machine learning server 410. Patching module 418 processes high-resolution climate data included in training data 422 and generates patched high-resolution climate data and one or more patch identifiers. In some embodiments, patching module 418 divides global high-resolution climate fields included in the high-resolution climate data, represented on a spherical grid, such as HEALPix or HPX grid, into overlapping local patches of fixed size, for example 128×128 pixels at HPX1024 resolution. The patch identifiers encode positional information, such as HEALPix face indices, patch coordinates, or learned positional embeddings, which are later used by super-resolution diffusion model 425 to reconstruct the correct spatial context. In some embodiments, the patched high-resolution climate data includes overlapping patches to permit continuity between adjacent regions and to enable overlap-weighted stitching during inference using super-resolution diffusion model 425. In some embodiments, patching module 418 further samples patches stochastically during training of super-resolution diffusion model 425 to increase data diversity and reduce memory requirements.

Loss calculator 416 is an application that executes on one or more processors 411 of machine learning server 410 and is stored in memory 412 of machine learning server 410. Loss calculator 416 calculates at least a first loss, a second loss, or a third loss based on at least one of (i) the masked data, the masked climate data, and the predicted masked climate data, (ii) the channel and temporal masks, the temporal masked climate data, and predicted temporal masked climate data, or (iii) the patched high-resolution climate data and the predicted patched high-resolution climate data. In some embodiments, the first loss includes a reconstruction loss that is normalized by the observed fraction of variables indicated by the channel masks included in the mask data, permitting that the first loss is only applied to observed values and not to missing variables. In some embodiments, the second loss includes a temporal reconstruction loss that is weighted by the temporal mask, such that the video diffusion model is penalized only on visible frames in a sequence while still learning to propagate dynamics into masked intervals. In some embodiments, the third loss includes a patch-based reconstruction loss, optionally combined with a patch overlap consistency loss to permit continuity between adjacent patches. In some embodiments, loss calculator 416 also includes perceptual losses, photometric consistency losses, and/or diffusion-specific denoising losses in the generated loss, depending on the training objective.

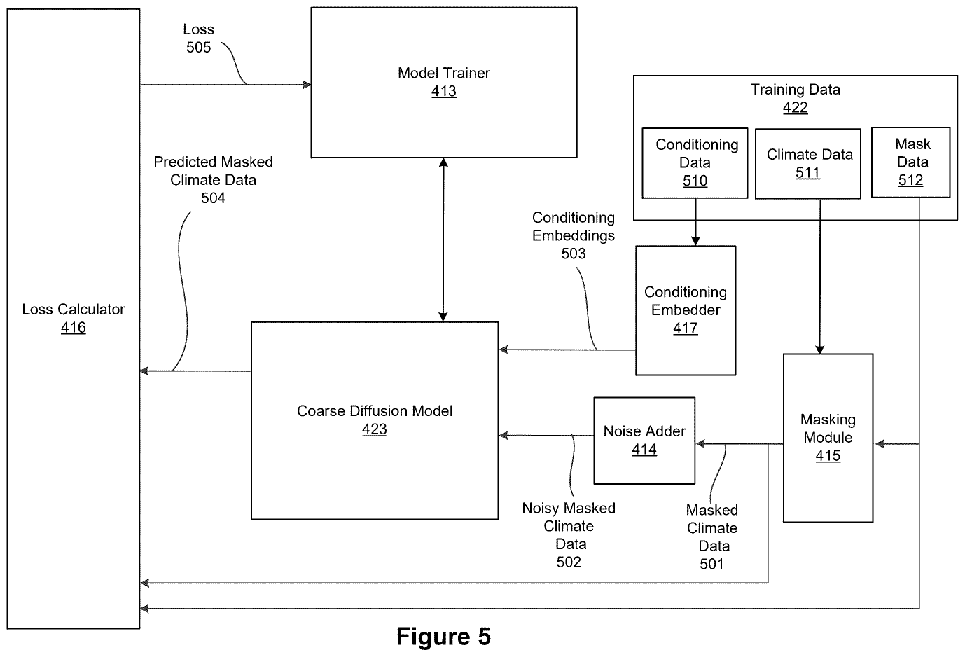

Model trainer 413 is an application that executes on one or more processors 411 of machine learning server 410 and is stored in memory 412 of machine learning server 410. Although shown as distinct from noise adder 414, masking module 415, loss calculator 416, conditioning embedder 417, temporal masking module 419, and patching module 418 for illustrative purposes, in some embodiments, functionality of model trainer 413, noise adder 414, masking module 415, loss calculator 416, conditioning embedder 417, temporal masking module 419, and patching module 418 can be combined into a single application. In some embodiments, model trainer 413 is configured to train one or more machine learning models, including coarse diffusion model 423, video diffusion model 424, and super-resolution diffusion model 425. Techniques for training coarse diffusion model 423, video diffusion model 424, and super-resolution diffusion model 425 based on training data 422 are discussed in greater detail herein in conjunction with at least FIGS. 5-7 and 9-12.

Coarse diffusion model 423 is a machine learning model, such as a neural network, which is trained to generate predicted masked climate data. In some embodiments, coarse diffusion model 423 includes a denoising network, such as a U-Net with spherical convolutional layers, residual connections, and cross-attention modules, that iteratively predicts cleaner climate states included in the predicted masked climate data from the noisy masked climate data at each denoising step.

Video diffusion model 424 is a machine learning model, such as a neural network, which is trained to generate the predicted temporal masked climate data. In some embodiments, video diffusion model 424 includes a U-Net backbone with spherical convolutional layers for spatial feature extraction, interleaved with temporal self-attention layers that capture dependencies across multiple timesteps. In some embodiments, video diffusion model 424 adds relative time embeddings to the inputs to represent temporal offsets, while per-frame calendar and SST conditioning included in the first conditioning embeddings provide context for seasonal and interannual variability.

Super-resolution diffusion model 425 is a machine learning model, such as a neural network, which is trained to generate the predicted patched high-resolution climate data. In some embodiments, super-resolution diffusion model 425 includes a U-Net backbone with convolutional layers, residual blocks, and cross-attention modules configured to operate on local patches of a spherical grid, such as HEALPix or HPX patches at HPX1024 resolution. Coarse diffusion model 423, video diffusion model 424, and super-resolution diffusion model 425 can be stored in data store 420. Although shown as being stored in data store 420 in FIG. 4, coarse diffusion model 423, video diffusion model 424, and super-resolution diffusion model 425 can be stored in memory 412 during training or can be stored in memory 412 during inference. In some embodiments, the same computing device(s) can be used for training and inference after training, rather than the separate machine learning server 410 and computing device 440. In some embodiments, data store 420 can include any storage device or devices, such as fixed disc drive(s), flash drive(s), optical storage, network attached storage (NAS), and/or a storage area-network (SAN). Although shown as accessible over network 430, in at least one embodiment machine learning server 410 can include data store 420.

Processor(s) 442 receive user input from input devices, such as a keyboard or a mouse. Processor(s) 442 could include one or more primary processors of computing device 440, controlling and coordinating operations of other system components. In particular, processor(s) 442 can issue commands that control the operation of one or more GPUs (not shown) and/or other parallel processing circuitry (e.g., parallel processing units, deep learning accelerators, etc.) that incorporates circuitry optimized for graphics and video processing, including, for example, video output circuitry. The GPU(s) can deliver pixels to a display device that can be any conventional cathode ray tube, liquid crystal display, light-emitting diode display, and/or the like.

Memory 444 of computing device 440 stores content, such as software applications and data, for use by processor(s) 442 and the GPU(s) and/or other processing units. Memory 444 can be any type of memory capable of storing data and software applications, such as a RAM, a ROM, an EPROM or Flash ROM, or any suitable combination of the foregoing. In some embodiments, a storage (not shown) can supplement or replace memory 444. The storage can include any number and type of external memories that are accessible to processor 442 and/or the GPU. For example, and without limitation, the storage can include a Secure Digital Card, an external Flash memory, a portable CD-ROM, an optical storage device, a magnetic storage device, and/or any suitable combination of the foregoing.

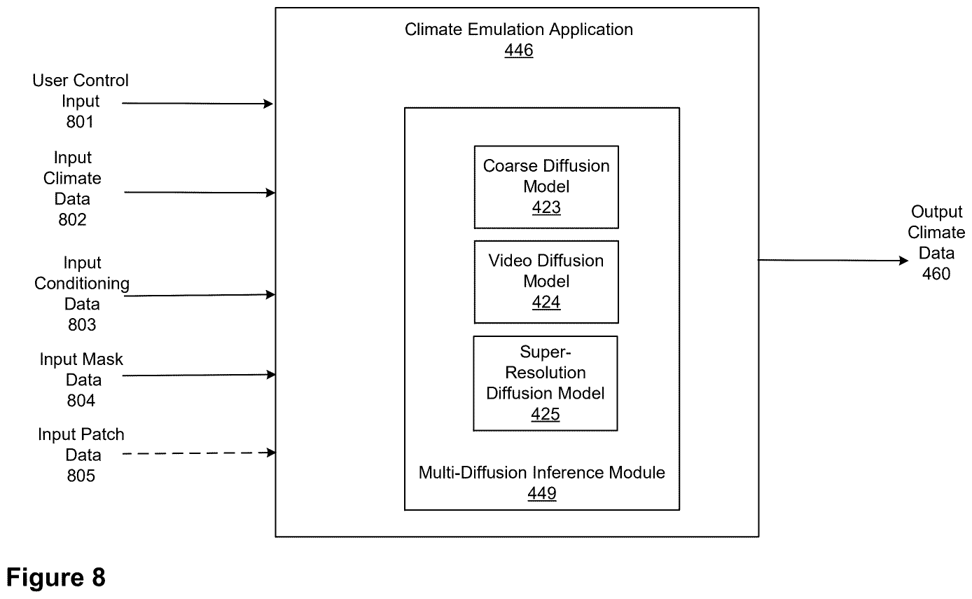

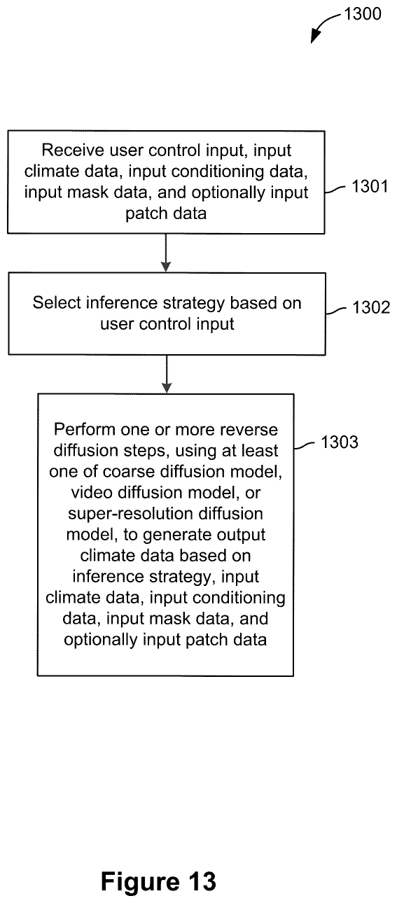

As shown, a climate emulation application 446 that uses the trained coarse diffusion model 423, the trained video diffusion model 424, and the trained super-resolution diffusion model 425 is stored in memory 444, and executes on processor(s) 442, of computer device 440. Once trained, the trained coarse diffusion model 423, the trained video diffusion model 424, and the trained super-resolution diffusion model 425 can be deployed, such as via multi-diffusion inference module 449 included in climate emulation application 446, to process a user control input, input climate data, input conditioning data, input mask data, and optionally input patch data and generate output climate data 460. Climate emulation application 446 is described in greater detail herein in conjunction with at least with FIGS. 8 and 13.

Output climate data 460 includes the generated climate fields produced by climate emulation application 446. In some embodiments, output climate data 460 includes global or regional atmospheric and oceanic state variables on a spherical grid, such as temperature, pressure, humidity, winds, sea surface temperature fields, and/or the like. In some embodiments, output climate data 460 is rendered at coarse, medium, or high spatial resolutions depending on whether coarse diffusion model 423, video diffusion model 424, or super-resolution diffusion model 425 is applied during inference. For example, output climate data 460 can include kilometer-scale maps generated by super-resolution diffusion model 425 based on coarse-resolution input climate data. In some embodiments, output climate data 460 is generated as a sequence of frames representing temporal evolution of the climate system, such as 3-day windows at 6-hour resolution, to capture dynamics and variability. In some embodiments, output climate data 460 visualizes reconstructed, downscaled, bias-corrected, or counterfactual scenarios, enabling interactive exploration and analysis by users. Output climate data 460 can be stored in data store 420, memory 444, or elsewhere, or displayed on computing device 440 for visualization and/or further processing.

FIG. 5 illustrates how model trainer 413 trains coarse diffusion model 423, according to various embodiments. As shown, training data 422 includes, without limitation, conditioning data 510, climate data 511, and mask data 512. Conditioning embedder 417 processes conditioning data 510 and generates conditioning embeddings 503. Masking module 415 processes climate data 511 and mask data 512 and generates masked climate data 501. Noise adder 414 adds noise to masked climate data 501 to generate noisy masked climate data 502. Coarse diffusion model 423 performs a denoising step to generate predicted masked climate data 504 based on conditioning embeddings 503 and noisy masked climate data 502. Loss calculator 416 calculates loss 505 based on predicted masked climate data 504, masked climate data 501, and mask data 512. Model trainer 413 updates the one or more parameters of coarse diffusion model 423 based on loss 505.

Conditioning embedder 417 processes conditioning data 510 and generates conditioning embeddings 503. In some embodiments, conditioning embedder 417 transforms conditioning data 510 into one or more embedding vectors (e.g., conditioning embeddings 503) using neural encoders, lookup tables, positional encoding functions, and/or the like. In some embodiments, conditioning embedder 417 embeds calendar information included in conditioning data 510 using sinusoidal functions of day-of-year (DOY) and time-of-day (t) that respect annual and diurnal periodicity. For example, the calendar embedding can be defined as given in Equation 1.

$${f}_{4 k} = cos ( \frac{2 π k \cdot doy}{365.25} ) , {f}_{4 k + 1} = sin ( \frac{2 π k \cdot doy}{365.25} ) \qquad ( Equation 1 )$$

$${f}_{4 k + 2} = cos ( kt ) , {f}_{4 k + 3} = sin ( kt )$$

In Equation 1, doy is the day of the year, and t is the local solar time expressed in radians as described in Equation 2.

$$t = 2 π ( \frac{second of day}{86400} + \frac{lon}{360} ) \qquad ( Equation 2 )$$

In Equation 2, second_of_day is the number of elapsed seconds since 00:00:00 UTC on the date of the sample (an integer in [0,86,399]), and lon is the geodetic longitude of the grid cell in degrees east (positive eastward; mapped to [0,360) or [−180,180) and normalized by 360 to a fractional day offset). In some embodiments, conditioning embedder 417 concatenates multiple harmonics (e.g., k=1, . . . ,8) to form the full embedding vector included in conditioning embeddings 503, which captures seasonal and diurnal cycles. In some embodiments, conditioning embedder 417 embeds SST fields using convolutional encoders. In some embodiments, conditioning embedder 417 further applies a learned positional embedding to each pixel of the spherical grid, initialized with random values and optimized during training, to allow coarse diffusion model 423 to represent non-stationary climatological structures. The resulting conditioning embeddings 503 are concatenated or projected into a latent space that aligns with the inputs of coarse diffusion model 423.

Masking module 415 processes mask data 512 and climate data 511 and generates masked climate data 501. In some embodiments, masking module 415 applies channel masks included in mask data 512 to zero out or otherwise replace values for at least one of unobserved, unknown, or undetermined atmospheric variables included in climate data 511 while preserving values for observed variables. In some embodiments, masking module 415 uses spatial masks included in mask data 512 to restrict visibility to specified regions of a spherical grid, such as a HEALPix or HPX grid, which permits training on partial climate data or guidance by region-specific inputs.

Noise adder 414 adds noise to masked climate data 501 to generate noisy masked climate data 502. In some embodiments, noise adder 414 includes a noise scheduler that defines how Gaussian noise is sampled and applied at different timesteps of the diffusion process. In some embodiments, the noise scheduler implements a log-uniform distribution across a range of variances [σₘᵢₙ,σₘₐₓ], where σₘᵢₙ is chosen large enough to mask strong climatological signals included in masked climate data 501, such as seasonal or diurnal cycles, and σₘₐₓ is chosen to permit sufficient variance coverage for all channels on the spherical grid. For example, the bounds can be determined by the conditions described in Equation 3.

$${σ}_{min}^{2} ≲ {inf}_{‖ v ‖ = 1} E [ {\vert {v}^{⊤} x \vert}^{2} ] , {σ}_{max}^{2} ≳ {sup}_{‖ v \vert \vert = 1} E [ {\vert {v}^{⊤} x \vert}^{2} ] \qquad ( Equation 3 )$$

In Equation 3, x represents the atmospheric state vector and v is any unit vector in the input space. In some embodiments, σₘᵢₙ is selected via power-spectral analysis of atmospheric observables, while σₘₐₓ is selected based on the dimensionality of the grid so that

$${σ}_{max}^{2} ≳ n ,$$

where n is the number of pixels times channels. In some embodiments, to train diffusion models, such as coarse diffusion model 423, on the sphere, noise adder 414 draws a per-pixel noise independently as ∈ᵢ~ [symbol] (0,1) for every pixel index i with 1≤i≤12· [symbol] , where [symbol] is the HEALPix level with N_{side}= [symbol] and Nₚᵢₓ=12,

$${N}_{s i d e}^{2} = 12 \cdot {4}^{ℓ} .$$

Because HEALPix pixels are equal-area, the independent and identically distributed (i.i.d.) sampling of per-pixel noise is equivalent to the pixel-wise average of a finite-variance continuous Gaussian process on the sphere. By drawing noise from the log-uniform schedule and sampling the noise independently per spherical pixel, noise adder 414 enables model trainer 413 to train coarse diffusion model 423 to denoise across a wide dynamic range of atmospheric variability while avoiding signal leakage from dominant seasonal or diurnal modes. In some examples, specific numerical values are used for the bounds of the noise scheduler, such as σₘᵢₙ=0.02 and σₘₐₓ=200, which span the dynamic range of the atmospheric variables included in climate data 511.

Coarse diffusion model 423 processes conditioning embeddings 503 and noisy masked climate data 502 and generates predicted masked climate data 504. In some embodiments, coarse diffusion model 423 includes a denoising network, such as a U-Net with spherical convolutional layers, residual connections, and cross-attention modules, that iteratively predicts cleaner climate states included in predicted masked climate data 504 from noisy masked climate data 502 at each denoising step. In some embodiments, coarse diffusion model 423 is trained using a score-based diffusion framework, in which the forward process gradually corrupts masked climate data with Gaussian-distributed noise, and the reverse process learns to denoise and recover the original atmospheric state included in masked climate data 501. In some examples, the forward process is defined as given in Equation 4.

x_{T}~ [symbol] (0,σₘₐₓ),xₜ=x₀+σ∈,∈~ [symbol] (0,I). (Equation 4)

In some embodiments, coarse diffusion model 423 includes a denoising network (e.g., denoising function) [symbol] (·;σ) that approximates a score function, such as

$${∇}_{x} log p ( x ; σ ) \approx \frac{{𝒟}_{θ} ( x ; σ ) - x}{{σ}^{2}} .$$

In some embodiments, during inference, coarse diffusion model 423 employs an Elucidated Diffusion Model (EDM) sampler, which integrates the reverse-time ordinary differential equation given in Equation 5.

$$\frac{d x}{dt} = - \dot{σ} ( t ) σ ( t ) {∇}_{x} log p ( x ; σ ( t ) ) \qquad ( Equation 5 )$$

In Equation 5, σ(t) is the noise schedule and \dot{σ}(t) its derivative, with a sampling algorithm. In some embodiments, coarse diffusion model 423 is implemented as a U-Net architecture adapted to spherical domains, with spherical convolutional layers for HEALPix grids, residual connections for stable optimization, and cross-attention modules that process conditioning embeddings 503. Let y denote climate data 512, ŷ denote predicted masked climate data 504, n denote the added noise, and m∈{0,1}^{B×C×N} denote mask data 512, where m=1 indicates observed values and m=0 indicates missing values, B is the batch size, C is the number of atmospheric variables or channels included in climate data 511 (e.g., temperature, wind, humidity, precipitation), and N is the number of spatial positions, such as the number of pixels in the HEALPix grid. In some examples, coarse diffusion model 423 generates predicted masked climate data 504 as described in Equation 6.

ŷ′= [symbol] (m·(y+n),σ), (Equation 6)

In Equation 6, inputs at missing positions (m=0) are set to zero before denoising.

Loss calculator 416 calculates loss 505 based on predicted masked climate data 504, mask data 512, and masked climate data 501. In some embodiments, loss 505 includes a reconstruction loss that is normalized by the observed fraction of variables indicated by the channel masks included in mask data 512, permitting that loss 505 is only applied to observed values and not to missing variables. In some examples, loss calculator 416 calculates loss 505 as described in Equation 7.

$$ℒ = \frac{1}{m e a n ( m )} {Σ}_{b = 1}^{B} {Σ}_{c = 1}^{C} {Σ}_{i = 1}^{N} {{m}_{b , c , i} ( {\hat{y}}_{b , c , i}^{′} - {y}_{b , c , i} )}^{2} . \qquad ( Equation 7 )$$

Equation 7 ensures that coarse diffusion model 423 is penalized only for errors on observed variables and that loss 505 is normalized by the fraction of observed entries mean (m), preventing bias toward variables or regions with greater coverage. In some embodiments, loss calculator 416 includes additional weighting terms so that atmospheric channels with fewer available observations contribute equally to the training objective, enabling coarse diffusion model 423 to learn a balanced representation across heterogeneous datasets.

In some embodiments, model trainer 413 updates the parameters of coarse diffusion model 423 based on loss 505. In some embodiments, model trainer 413 updates the parameters using a gradient-based optimizer, such as adaptive moment estimation (Adam), with fixed learning rate, such as 1×10⁻⁴. In some embodiments, model trainer 413 uses the order of millions of examples from training data 422, such as approximately 9,856,000 samples, with a fixed batch size, such as 64 corresponding to roughly 3 million images or 256 corresponding to roughly ten million images. In some embodiments, training proceeds until a stopping criterion is met. The stopping criterion includes, without limitation, reaching a maximum number of training epochs, such as 250, observing convergence of a validation loss below a predefined threshold, or detecting no improvement in validation performance for a fixed number of epochs, such as ten epochs, to prevent overfitting. In some embodiments, model trainer 413 uses early stopping terminate training when validation loss plateaus, while model trainer 413 uses checkpointing to ensure that the best-performing version of coarse diffusion model 423 is retained for inference. Once coarse diffusion model 423 is trained, model trainer 413 stores the trained coarse diffusion model 423 in data store 420 or elsewhere.

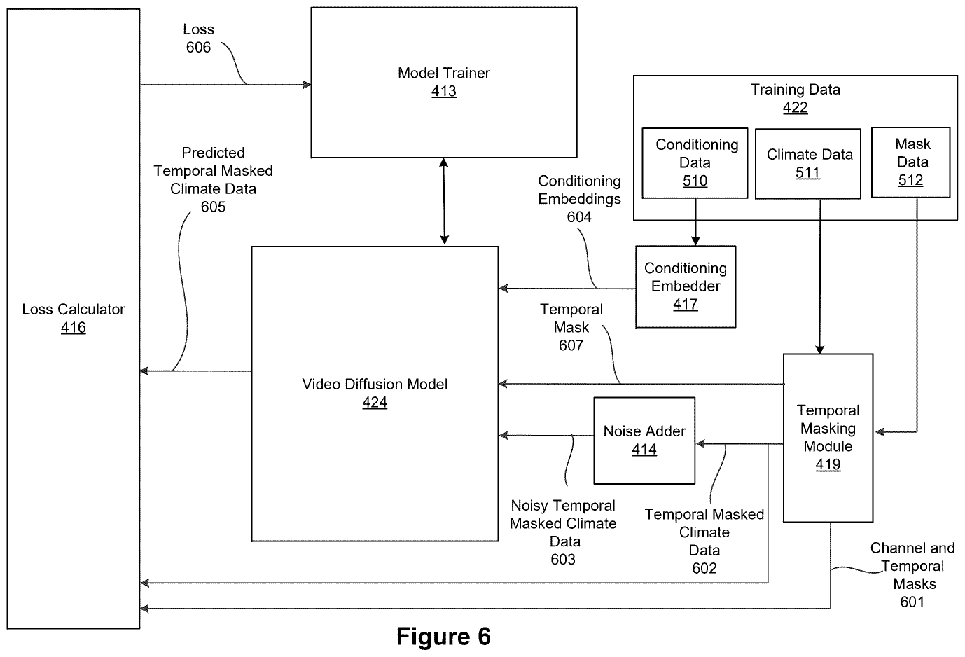

FIG. 6 illustrates how model trainer 413 trains video diffusion model 424, according to various embodiments. As shown, training data 422 includes, without limitation, conditioning data 510, climate data 511, and mask data 512. Conditioning embedder 417 processes conditioning data 510 and generates conditioning embeddings 604. Temporal masking module 419 processes climate data 511 and mask data 512 and generates temporal masked climate data 602, temporal mask 607, and channel and temporal masks 601. Noise adder 414 adds noise to temporal masked climate data 602 to generate noisy temporal masked climate data 603. Video diffusion model 424 performs a denoising step to generate predicted temporal masked climate data 605 based on conditioning embeddings 604, temporal mask 607, and noisy temporal masked climate data 603. Loss calculator 416 calculates loss 606 based on predicted temporal masked climate data 605, temporal masked climate data 602, and channel and temporal masks 601. Model trainer 413 updates the one or more parameters of video diffusion model 424 based on loss 606.

Conditioning embedder 417 processes conditioning data 510 and generates conditioning embeddings 604. In some embodiments, conditioning embedder 417 transforms conditioning data 510 into one or more embedding vectors (e.g., conditioning embeddings 604) using neural encoders, lookup tables, positional encoding functions, and/or the like. In some embodiments, conditioning embedder 417 embeds calendar information included in conditioning data 510 using sinusoidal functions day-of-year and time-of-day (t) that respect annual and diurnal periodicity. For example, the calendar embedding can be defined as given in Equation 1. In some embodiments, conditioning embedder 417 concatenates multiple harmonics (e.g., k=1, . . . ,8) to form the full embedding vector included in conditioning embeddings 604, which captures seasonal and diurnal cycles. In some embodiments, conditioning embedder 417 embeds SST fields using convolutional encoders. In some embodiments, conditioning embedder 417 further applies a learned positional embedding to each pixel of the spherical grid, initialized with random values and optimized during training, to allow video diffusion model 424 to represent non-stationary climatological structures. The resulting conditioning embeddings 604 are concatenated or projected into a latent space that aligns with the inputs of video diffusion model 424.

Temporal masking module 419 processes mask data 512 and climate data 511 and generates temporal mask 607, temporal masked climate data 602, and channel and temporal masks 601. In some embodiments, temporal masking module 419 applies temporal masks included in mask data 512 to designate which frames in a sequence of climate data 511 are visible for video diffusion model 424 during training. By selectively withholding certain frames, temporal masking module 419 enables video diffusion model 424 to learn to propagate dynamics across missing intervals and improves the ability to reconstruct physically consistent sequences. In some embodiments, temporal masking module 419 further combines temporal masks with channel masks included in mask data 512 to generate channel and temporal masks 601, allowing video diffusion model 424 to simulate scenarios where certain variables are missing for specific time steps. In some embodiments, temporal masking module 419 implements masked-conditioning strategies inspired by Masked Conditional Video Diffusion (MCVD). During training of video diffusion model 424, temporal masking module 419 samples mask patterns m∈{0,1}^{T}, where 1 indicates an observed frame, from a categorical distribution pₘₐₛₖ that blends several tasks. The tasks include at least one of Bernoulli random frame dropout, masking all but the first or last few frames contiguously, masking middle frames while keeping endpoints visible, and full sequence masking. In some embodiments, the masked sequence (e.g., ground truth at unmasked positions and zeros at masked positions) included in temporal masked climate data 602 and the binary mask indicator included in channel and temporal masks 601 are concatenated channel-wise with other conditioning inputs included in conditioning embeddings 604, such as calendar embeddings or monthly mean SST embeddings.

Noise adder 414 adds noise to masked temporal masked climate data 602 to generate noisy temporal masked climate data 603. In some embodiments, noise adder 414 includes a noise scheduler that defines how Gaussian noise is sampled and applied at different timesteps of the diffusion process. In some embodiments, the noise scheduler implements a log-uniform distribution across a range of variances [σₘᵢₙ,σₘₐₓ], where σₘᵢₙ (e.g., lower variance bound) is chosen large enough to mask strong climatological signals included in temporal masked climate data 602 and σₘₐₓ (e.g., upper variance bound) is chosen to permit sufficient variance coverage for all channels on the spherical grid. For example, the bounds can be determined by the conditions described in Equation 3. In some embodiments, to train diffusion models, such as video diffusion model 424, on the sphere, noise adder 414 draws a per-pixel noise independently as ∈ᵢ~ [symbol] (0,1) for every pixel index i with 1≤i≤12· [symbol] . Because HEALPix pixels are equal-area, the i.i.d. sampling of per-pixel noise is equivalent to the pixel-wise average of a finite-variance continuous Gaussian process on the sphere. By drawing noise from the log-uniform schedule and sampling the noise independently per spherical pixel, noise adder 414 enables model trainer 413 to train video diffusion model 424 to denoise across a wide dynamic range of atmospheric variability while avoiding signal leakage from dominant seasonal or diurnal modes. In some examples, specific numerical values are used for the bounds of the noise scheduler, such as σₘᵢₙ=0.02 and σₘₐₓ∈[200, 1000], which span the dynamic range of the atmospheric variables included in climate data 511.

Video diffusion model 424 processes conditioning embeddings 604, temporal mask 607, and noisy temporal masked climate data 603 and generates predicted temporal masked climate data 605. In some embodiments, video diffusion model 424 includes a U-Net backbone with spherical convolutional layers for spatial feature extraction, interleaved with temporal self-attention layers inserted at multiple positions within the encoder and decoder resolution stages to capture dependencies across timesteps. In some embodiments, video diffusion model 424 is configured to process short sequences of noisy temporal masked climate data 603 (e.g., 3-day windows with 6-hour resolution, corresponding to 12 frames). In some embodiments, video diffusion model 424 adds relative time embeddings to the inputs to represent temporal offsets, while per-frame calendar and SST conditioning included in conditioning embeddings 604 provide context for seasonal and interannual variability.

Loss calculator 416 calculates loss 606 based on predicted temporal masked climate data 605, channel and temporal masks 601, and temporal masked climate data 602. In some embodiments, loss 606 includes a reconstruction loss that is normalized by the observed fraction of variables and timesteps indicated by channel and temporal masks 601, permitting that loss 606 is only applied to observed variables and visible frames rather than missing variables or masked timesteps. In some examples, loss calculator 416 calculates loss 606 as described in Equation 8.

$$L = \frac{1}{m e a n ( m )} {Σ}_{b = 1}^{B} {Σ}_{c = 1}^{C} {Σ}_{C = 1}^{T} {Σ}_{i = 1}^{N} {{m}_{b , c , t , i} ( {\hat{y}}_{b , c , t , i}^{′} - {y}_{b , c , t , i} )}^{2} \qquad ( Equation 8 )$$

In equation 8, T is the number of temporal frames, m_{b,ct,i} is the channel and temporal mask value (1 for observed, 0 for missing) included in channel and temporal masks 601, y_{b,c,t,i} is the ground truth temporal masked climate data 602, and

$${\hat{y}}_{b , c , t , i}^{′}$$

is the predicted temporal masked climate data 605. Equation 8 ensures that video diffusion model 424 is penalized only for reconstruction errors on observed spatiotemporal variables and that loss 606 is normalized by the fraction of observed entries mean (m), preventing bias toward more frequently observed channels or timesteps. In some embodiments, loss calculator 416 includes additional weighting terms so that variables with fewer temporal observations or shorter time coverage contribute equally to the training objective, enabling video diffusion model 424 to learn balanced spatiotemporal representations across heterogeneous datasets.

In some embodiments, model trainer 413 updates the parameters of video diffusion model 424 based on loss 606. In some embodiments, model trainer 413 updates the parameters using a gradient-based optimizer, such Adam, with a fixed learning rate, such as 1×10⁻⁴. In some embodiments, model trainer 413 uses on the order of millions of examples from training data 422, such as approximately 2,160,000 video samples, with a fixed batch size, such as 32. In some embodiments, training proceeds until a stopping criterion is met. The stopping criterion includes, without limitation, reaching a maximum number of training epochs, such as 250, observing convergence of a validation loss below a predefined threshold, or detecting no improvement in validation performance for a fixed number of epochs, such as ten epochs, to prevent overfitting. In some embodiments, model trainer 413 uses early stopping to terminate training when validation loss plateaus, while model trainer 413 uses checkpointing to ensure that the best-performing version of video diffusion model 424 is retained for inference. Once video diffusion model 424 is trained, model trainer 413 stores the trained video diffusion model 424 in data store 420 or elsewhere.

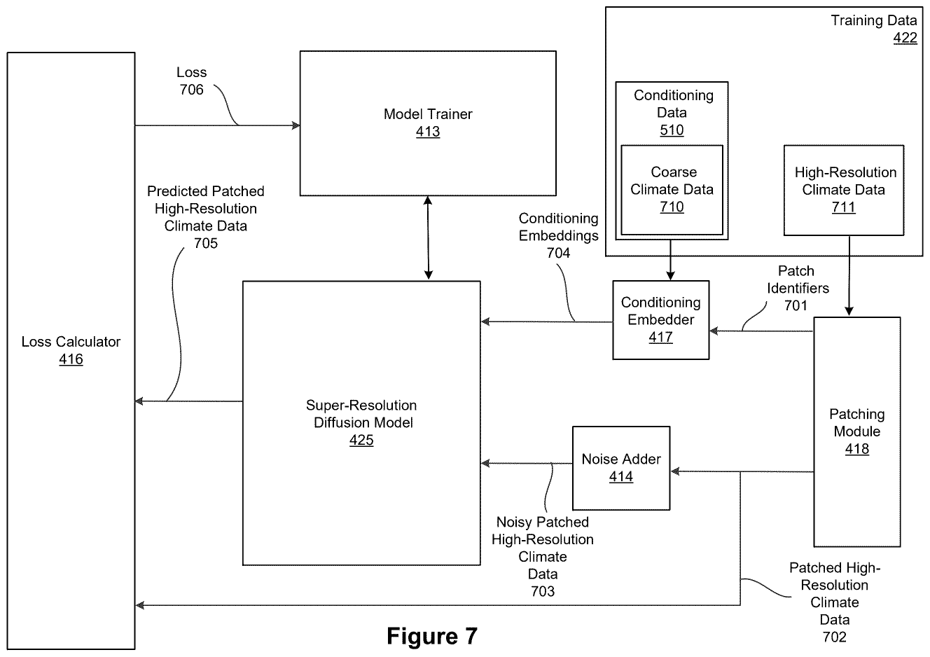

FIG. 7 illustrates how model trainer 413 trains super-resolution diffusion model 424, according to various embodiments. As shown, training data 422 includes, without limitation, conditioning data 510 and high-resolution climate data 711. Conditioning data 510 includes, without limitation, coarse climate data 710. In operation, patching module 418 processes high-resolution climate data 711 and generates one or more patch identifiers 701 and patched high-resolution climate data 702. Conditioning embedder 417 processes patch identifiers 701 and coarse climate data 710 and generates conditioning embeddings 704. Noise adder 414 adds noise to patched high-resolution climate data 702 and generates noisy patched high-resolution climate data 703. Super-resolution diffusion model 425 performs a denoising step to generate predicted patched high-resolution climate data 705 based on conditioning embeddings 704 and noisy patched high-resolution climate data 703. Loss calculator 416 calculates loss 706 based on patched high-resolution climate data 702 and predicted patched high-resolution climate data 705. Model trainer 413 updates the one or more parameters of super-resolution diffusion model 425 based on loss 706.

Patching module 418 processes high-resolution climate data 711 and generates patch identifiers 701 and patched high-resolution climate data 702. In some embodiments, patching module 418 divides global high-resolution climate fields included in high-resolution climate data 711, represented on a spherical grid, such as HEALPix or HPX grid, into overlapping local patches of fixed size, for example 128×128 pixels at HPX1024 resolution. The patch size (128×128) is chosen to balance resolution with computational feasibility, being much larger than standard 16×super-resolution factors yet still affordable for training and inference. In some examples, coarse climate data 710 with resolution HPX64 can be re-gridded bilinearly to the HPX1024 128×128 patch and interpolated onto a lat-lon grid of resolution (128×128). In some embodiments, patched high-resolution climate data 702 includes overlapping patches to permit continuity between adjacent regions and to enable overlap-weighted stitching during inference using super-resolution diffusion model 425. In some examples, patching module 418 can process tens of millions of patches (e.g., on the order of 191 million patches derived from ~95,520 ICON samples) with batching strategies, such as a batch size of 960 to ensure tractable optimization at scale. In some embodiments, patching module 418 further samples patches stochastically during training of super-resolution diffusion model 425 to increase data diversity and reduce memory requirements.

Conditioning embedder 417 processes conditioning data 510 and patch identifiers 701 and generates conditioning embeddings 704. In some embodiments, conditioning embedder 417 incorporates patch identifiers 701 to encode the spatial location of patched high-resolution climate data 702 within the global HEALPix grid included in coarse climate data 710. In some embodiments, to cope with non-stationary spatial features, conditioning embedder 417 introduces learnable positional embeddings defined on the HPX1024 grid, which can be initialized using sinusoidal functions and optimized during training. The positional embeddings are concatenated with global positional embeddings of the lat-lon grid corresponding to each patch, thereby linking patch-local coordinates to the global spherical structure. In some embodiments, conditioning embedder 417 transforms patch identifiers 701 into positional indices or embeddings that disambiguate overlapping patches and preserve global spatial coherence. In some embodiments, conditioning embedder 417 concatenates or fuses the patch identifier embeddings with embeddings derived from conditioning data 510, such as coarse climate data 710, calendar information, or sea surface temperature fields, to provide spatially localized conditioning context.

Noise adder 414 adds noise to patched high-resolution climate data 702 to generate noisy patched high-resolution climate data 703. In some embodiments, noise adder 414 includes a noise scheduler that defines how Gaussian noise is sampled and applied at different timesteps of the diffusion process. In some embodiments, for training super-resolution diffusion model 425, the noise scheduler uses a lognormal distribution of noise levels, parameterized by a mean Pₘₑₐₙ and standard deviation P_{std} in log space. For example, the log-normal schedule can be specified with values such as Pₘₑₐₙ=−1.2 and P_{std}=1.2, which determine the distribution of noise magnitudes across denoising steps. In some embodiments, to train on the sphere, noise adder 414 draws per-pixel noise independently as ∈ᵢ~ [symbol] (0,1) for every pixel index i with 1≤i≤12·4^{l}, where l is the HEALPix level, N_{side}=2^{l}, and Nₚᵢₓ=12.

$${N}_{s i d e}^{2} .$$

By applying noise sampled from the log-normal distribution, noise adder 414 enables model trainer 413 to train super-resolution diffusion model 425 to reconstruct high-frequency local details while maintaining global consistency across patches.

Super-resolution diffusion model 425 processes conditioning embeddings 704 and noisy patched high-resolution climate data 703 and generates predicted patched high-resolution climate data 705. In some embodiments, super-resolution diffusion model 425 includes a U-Net backbone with convolutional layers, residual blocks, and cross-attention modules configured to operate on local patches of a spherical grid, such as HEALPix or HPX patches at HPX1024 resolution. In some embodiments, super-resolution diffusion model 425 replaces a conventional global denoiser with an aggregated local denoiser that operates patch-by-patch across the global feature map included in conditioning embeddings 704, denoising overlapping regions in a sliding-window fashion and then reassembling the results to reconstruct the global state included in predicted patched high-resolution climate data 705. The multi-diffusion strategy allows kilometer-scale resolution while maintaining global consistency. Let χ_{θ}:χ_{local}× [symbol] × [symbol] →χ_{local} denote the learned local denoiser (e.g., a U-Net with cross-attention) parameterized by θ, where χ_{local}= [symbol] is the space of a noisy local patch included in noisy patched high-resolution climate data 703, [symbol] = [symbol] is the space of the local conditioning included in conditioning embeddings 704, and σ∈ [symbol] denote the noise level, such as a log-normal noise schedule. Given a local noisy patch uᵢ, local conditioning vᵢ, and noise level σ, the denoising network included in super-resolution diffusion model 425 outputs a denoised patch prediction ûᵢ=Φ_{θ}(uᵢ|vᵢ,σ)∈χ_{local}. In some examples, the global denoiser can be represented as an aggregation of local denoisers as described in Equation 9.

$${𝒟}_{θ} ( {x}_{t} ) = \frac{{Σ}_{i} {𝒢}_{i}^{- 1} ( {Φ}_{θ} ( {𝒢}_{i} ( {x}_{t} ) \vert {𝒢}_{i} ( y ) , σ ) )}{{Σ}_{i} {𝒢}_{i}^{- 1} ( {J}_{N} )} . \qquad ( Equation 9 )$$

In Equation 9, [symbol] (xₜ)= [symbol] ( [symbol] (xₜ;N/2), with [symbol] (·;N/2) a padding operator, [symbol] a 2D sampling operator, N the patch size, and J_{N} an all-one matrix of size N×N used to normalize overlapping regions. In Equation 9, [symbol] (y) (or equivalently [symbol] (y)) corresponds to conditioning embeddings 704, positional encodings derived from patch identifiers 701, calendar embeddings, and/or sea surface temperature fields. The embeddings provide localized context that guides the denoising of each patch. In some embodiments, the aggregation also operates according to Equation 10.

$${𝒟}_{θ} ( {x}_{t} ) = \frac{{Σ}_{i} {ℱ}_{i}^{- 1} ( {Φ}_{θ} ( {ℱ}_{i} ( {x}_{t} ) \vert {ℱ}_{i} ( y ) , σ ) )}{{Σ}_{i} {ℱ}_{i}^{- 1} ( {J}_{N} )} . \qquad ( Equation 10 )$$

### In Equation 10,

$${ℱ}_{i}^{- 1}$$

denotes the inverse mapping from local patch space back to the global domain and overlap between adjacent patches reduces boundary artifacts and improves spatial consistency. Introducing overlap between patches reduces stitching artifacts. However, the overlap has to be balanced against computational cost. For example, larger overlaps improve accuracy but require more denoiser evaluations, while minimal overlap achieves favorable efficiency-quality tradeoffs. In some embodiments, super-resolution diffusion model 425 performs localized patch denoising under conditioning embeddings 704, while the aggregation equations, such as Equations 9 and 10, ensure that the denoised patches, are recombined into globally consistent predicted patched high-resolution climate data 705.

Loss calculator 416 calculates loss 706 based on predicted patched high-resolution climate data 705 and patched high-resolution climate data 702. In some embodiments, loss 706 is defined as a denoising score matching objective applied at the patch level, ensuring that super-resolution diffusion model 425 learns to denoise local patches consistently while maintaining global coherence. In some examples, given training samples x~p_{data}, conditioning embeddings 704 y, noise ∈~ [symbol] (0,σ²I), and a patch sampling operator [symbol] that extracts a local patch, loss 706 can be described by Equation 11.

L(θ)= [symbol] [symbol] [symbol] _{(0,σ}_{²}₁₎ [symbol] ∥Φ_{θ}( [symbol] (x)+∈; [symbol] (y),σ)− [symbol] (x)∥². (Equation 11)

In Equation 11, [symbol] (x) extracts a patch of size N×N from x, and the expectation over i~ [symbol] ensures uniform random sampling of patches across the spherical grid. In some embodiments, loss 706 is averaged over all patches and normalized to prevent bias toward regions with denser coverage. In some embodiments, loss 706 includes a patch-based reconstruction loss, optionally combined with a patch overlap consistency loss to permit continuity between adjacent patches. In some embodiments, loss calculator 416 also includes perceptual losses, photometric consistency losses, and/or diffusion-specific denoising losses in the generated loss 706, depending on the training objective.

In some embodiments, model trainer 413 uses loss 706 to update the one or more parameters of super-resolution diffusion model 425. In some embodiments, model trainer 413 updates the parameters using a gradient-based optimizer, such as stochastic gradient descent (SGD), with a fixed learning rate, such as 1×10⁻⁴. In some embodiments, model trainer 413 uses tens of thousands of global samples from training data 422, such as approximately 95,520 ICON samples corresponding to about 191 million 128×128 patches cropped from HPX1024 fields, with a fixed batch size, such as 960. In some embodiments, training proceeds until a stopping criterion is met. The stopping criterion includes, without limitation, reaching a maximum number of training epochs, such as 250, observing convergence of a validation loss below a predefined threshold, or detecting no improvement in validation performance for a fixed number of epochs, such as ten epochs, to prevent overfitting. In some embodiments, model trainer 413 uses early stopping to terminate training when validation loss plateaus, while model trainer 413 uses checkpointing to ensure that the best-performing version of super-resolution diffusion model 425 is retained for inference. Once super-resolution diffusion model 425 is trained, model trainer 413 stores the trained super-resolution diffusion model 425 in data store 420 or elsewhere.

FIG. 8 is a more detailed illustration of climate emulation application 446, according to various embodiments. As shown, climate emulation application 446 includes, without limitation, multi-diffusion inference module 449. Multi-diffusion inference module 449 includes, without limitation, coarse diffusion model 423, video diffusion model 424, and super-resolution diffusion model 425. In operation, climate emulation application 446 selects an inference strategy based on user control input 801. Multi-diffusion inference module 449 performs one or more reverse diffusion steps, using at least one of coarse diffusion model 423, video diffusion model 424, or super-resolution diffusion model 425, to generate output climate data 460 based on the inference strategy, input climate data 802, input conditioning data 803, input mask data 804, and optionally input patch data 805.

Climate emulation application 446 selects inference strategy based on user control input 801. In some embodiments, climate emulation application 446 uses user control input 801 to determine the type of climate task to be performed, and climate emulation application 446 invokes one or more of coarse diffusion model 423, video diffusion model 424, or super-resolution diffusion model 425, accordingly. In some embodiments, climate emulation application 446 supports a variety of applications, such as (i) climate emulation, (ii) channel in-filling, (iii) bias correction, (iv) downscaling, (v) what-if scenarios, and/or (vi) steerable sampling, based on the selected inference strategy. In climate emulation, at least one of coarse diffusion model 423 or video diffusion model 424 reproduce large-scale atmospheric dynamics included in output climate data 460. In channel in-filling, diffusion models reconstruct missing atmospheric or oceanic variables across time and space. In bias correction, outputs generated by the trained diffusion models are adjusted to reduce systematic deviations from observational data. In downscaling, super-resolution diffusion model 425 maps coarse-resolution climate data included in input climate data 802 to higher-resolution grids, such as HPX1024. In what-if scenarios, climate emulation application 446 propagates perturbed boundary or forcing conditions through the trained diffusion models to generate counterfactual or hypothetical climate outcomes. In steerable sampling, multi-diffusion inference module 449 guides reverse diffusion toward user-specified spatial or physical attributes, such as region masks, thresholds, or climatological indices, by clamping or conditioning values, during the generation of climate fields via reverse diffusion, using at least one of coarse diffusion model 423, video diffusion model 424, or super-resolution diffusion model 425. Climate emulation application 446 flexibly adapts the inference pipeline based on the selected inference strategy to meet user-specified objectives and produces output climate data 460 consistent with the selected application.

Multi-diffusion inference module 449 performs one or more reverse diffusion steps, using at least one of coarse diffusion model 423, video diffusion model 424, or super-resolution diffusion model 425, to generate output climate data 460 based on the inference strategy, input climate data 802, input conditioning data 803, input mask data 804, and optionally input patch data 805. In some embodiments, when the inference strategy corresponds to climate emulation, multi-diffusion inference module 449 applies at least one of coarse diffusion model 423, video diffusion model 424, or super-resolution diffusion model 425 to process input climate data 802 and input conditioning data 803 and reconstruct global climate states included in output climate data 460. When the inference strategy corresponds to channel in-filling, multi-diffusion inference module 449 applies super-resolution diffusion model 425 to process input climate data 802, input conditioning data 803, and input mask data 804 and reconstruct missing channels or timesteps included in output climate data 460. When the inference strategy corresponds to bias correction, multi-diffusion inference module 449 applies at least one of coarse diffusion model 423 or video diffusion model 424, to adjust systematic deviations in input climate data 802 relative to reference climatology included in input conditioning data 803. When the inference strategy corresponds to downscaling, multi-diffusion inference module 449 applies super-resolution diffusion model 425 to process input climate data 802, input conditioning data 803, and input patch data 805 and generate high-resolution output climate data 460 from coarse-resolution inputs. When the inference strategy corresponds to what-if scenario analysis, multi-diffusion inference module 449 applies at least one of coarse diffusion model 423, video diffusion model 424, or super-resolution diffusion model 425 to simulate counterfactual climate states based on input conditioning data 803, such as modified sea surface temperature fields, altered greenhouse gas concentrations, and/or the like. When the inference strategy corresponds to steerable sampling, multi-diffusion inference module 449 applies at least one of coarse diffusion model 423, video diffusion model 424, or super-resolution diffusion model 425 while clamping or conditioning selected values of input climate data 802 or input conditioning data 803 during reverse diffusion steps, to guide output climate data 460 toward user-specified spatial attributes, such as regional masks, thresholds, or climatological indices.

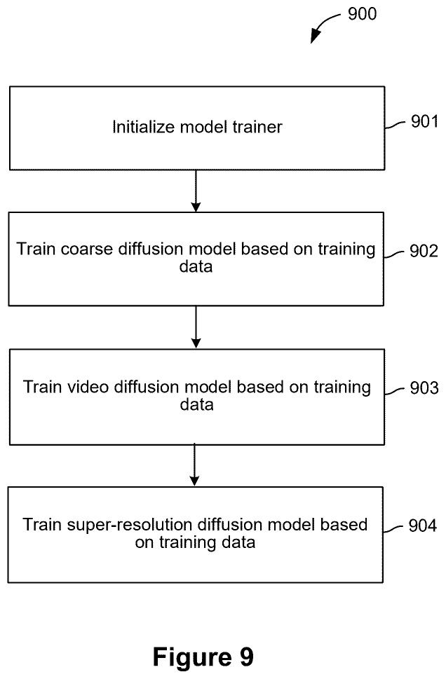

FIG. 9 is a flow diagram of method steps for training coarse diffusion model 423, video diffusion model 424, and super-resolution diffusion model 425, according to various embodiments. Although the method steps are described in conjunction with the systems of FIGS. 1-8, persons skilled in the art will understand that any system configured to perform the method steps in any order falls within the scope of the present embodiments.

A shown, a method 900 begins with step 901, where model trainer 413 is initialized. In some embodiments, model trainer 413 initializes a fixed learning rate, such as 1×10⁻⁴. In some embodiments, model trainer 413 initializes a fixed batch size, such as 64 for training coarse diffusion model 423, 32 for training video diffusion model 424, and 960 for training super-resolution diffusion model 425. In some embodiments, model trainer 413 initializes a fixed number of epochs, such as ten for training coarse diffusion model 423, 250 for training video diffusion model 424, and ten for training super-resolution diffusion model 425.

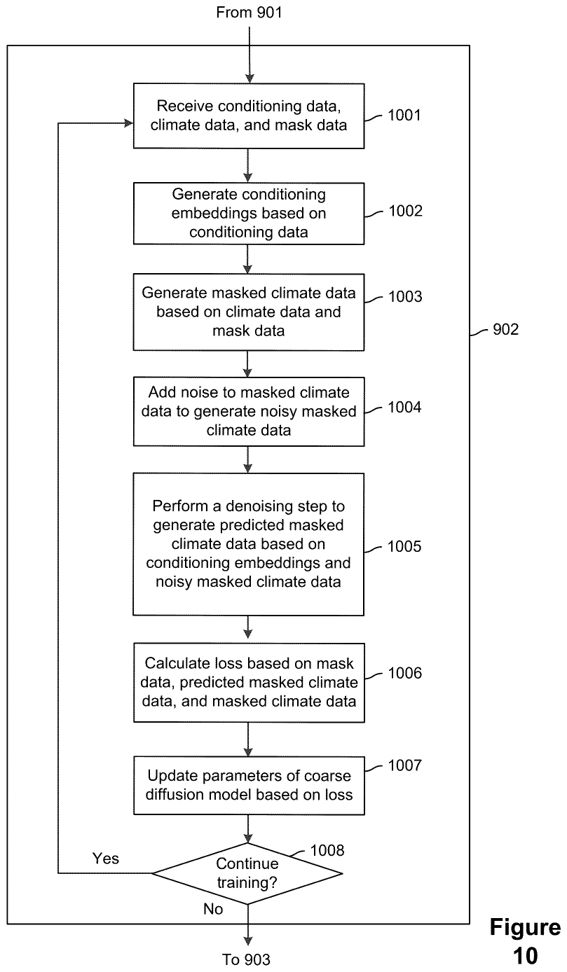

At step 902, model trainer 413 trains coarse diffusion model 423 based on training data 422. During the training, conditioning embedder 417 processes conditioning data 510 and generates conditioning embeddings 503. Masking module 415 processes climate data 511 and mask data 512 and generates masked climate data 501. Noise adder 414 adds noise to masked climate data 501 to generate noisy masked climate data 502. Coarse diffusion model 423 performs a denoising step to generate predicted masked climate data 504 based on conditioning embeddings 503 and noisy masked climate data 502. Loss calculator 416 calculates loss 505 based on predicted masked climate data 504, masked climate data 501, and mask data 512. Model trainer 413 updates the one or more parameters of coarse diffusion model 423 based on loss 505 until one or more stopping criteria are met. Once coarse diffusion model 423 is trained, model trainer 413 stores coarse diffusion model 423 in data store 420 or elsewhere. Step 902 is described in greater detail in conjunction with FIG. 10.

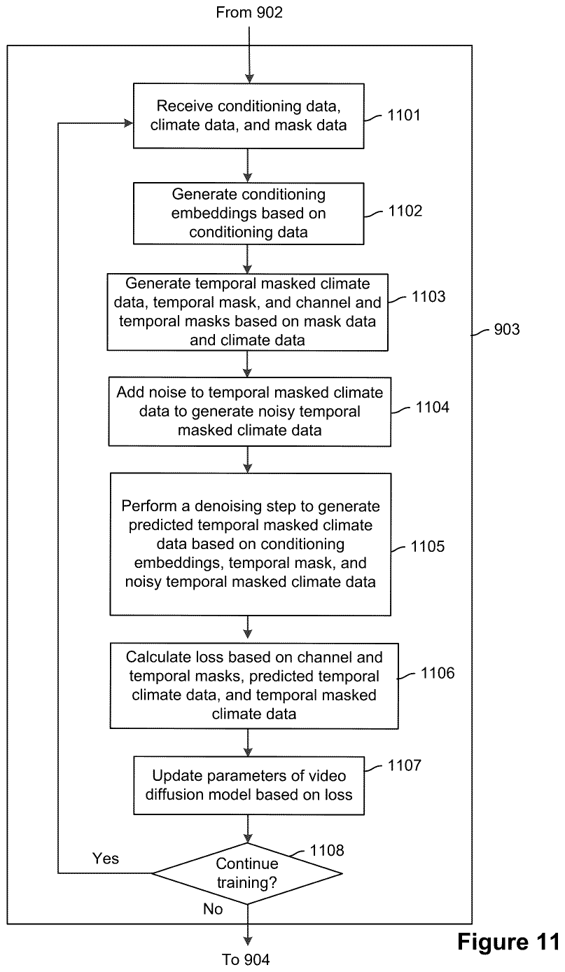

At step 903, model trainer 413 trains video diffusion model 424 based on training data 422. During the training, conditioning embedder 417 processes conditioning data 510 and generates conditioning embeddings 604. Temporal masking module 419 processes climate data 511 and mask data 512 and generates temporal masked climate data 602, temporal mask 607, and channel and temporal masks 601. Noise adder 414 adds noise to temporal masked climate data 602 to generate noisy temporal masked climate data 603. Video diffusion model 424 performs a denoising step to generate predicted temporal masked climate data 605 based on conditioning embeddings 604, temporal mask 607, and noisy temporal masked climate data 603. Loss calculator 416 calculates loss 606 based on predicted temporal masked climate data 605, temporal masked climate data 602, and channel and temporal masks 601. Model trainer 413 updates the one or more parameters of video diffusion model 424 based on loss 606 until one or more stopping criteria are met. Once video diffusion model 424 is trained, model trainer 413 stores video diffusion model 424 in data store 420 or elsewhere. Step 903 is described in greater detail in conjunction with FIG. 11.

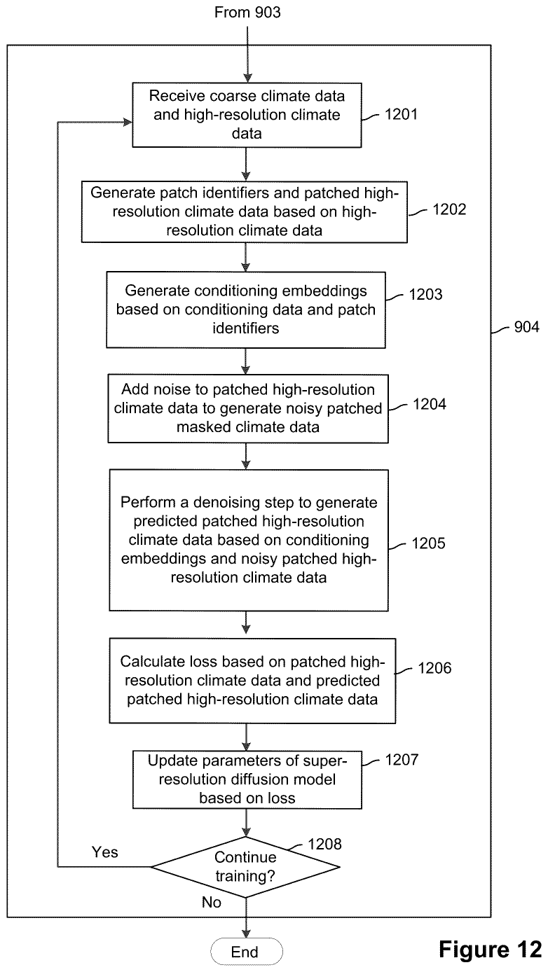

At step 904, model trainer 413 trains super-resolution diffusion model 425 based on training data 422. During the training, patching module 418 processes high-resolution climate data 711 and generates one or more patch identifiers 701 and patched high-resolution climate data 702. Conditioning embedder 417 processes patch identifiers 701 and coarse climate data 710 and generates conditioning embeddings 704. Noise adder 414 adds noise to patched high-resolution climate data 702 and generates noisy patched high-resolution climate data 703. Super-resolution diffusion model 425 performs a denoising step to generate predicted patched high-resolution climate data 705 based on conditioning embeddings 704 and noisy patched high-resolution climate data 703. Loss calculator 416 calculates loss 706 based on patched high-resolution climate data 702 and predicted patched high-resolution climate data 705. Model trainer 413 updates the one or more parameters of super-resolution diffusion model 425 based on loss 706 until one or more stopping criteria are met. Once super-resolution diffusion model 425 is trained, model trainer 413 stores super-resolution diffusion model 425 in data store 420 or elsewhere. In some embodiments, step 902, step 903, and step 904 are performed concurrently or sequentially. Step 904 is described in greater detail in conjunction with FIG. 12.

FIG. 10 is a flow diagram of method steps for training coarse diffusion model 423, according to various embodiments. Although the method steps are described in conjunction with the systems of FIGS. 1-8, persons skilled in the art will understand that any system configured to perform the method steps in any order falls within the scope of the present embodiments.

As shown, step 902 begins with step 1001, where conditioning embedder 417 receives conditioning data 510 and masking module 415 receives climate data 511 and mask data 512. In some embodiments, conditioning data 510, climate data 511, and mask data 512 are included in training data 422.

At step 1002, conditioning embedder 417 generates conditioning embeddings 503 based on conditioning data 510. In some embodiments, conditioning embedder 417 transforms conditioning data 510 into one or more embedding vectors (e.g., conditioning embeddings 503) using neural encoders, lookup tables, positional encoding functions, and/or the like. In some embodiments, conditioning embedder 417 embeds calendar information included in conditioning data 510 using sinusoidal functions of DOY and time-of-day (t) that respect annual and diurnal periodicity. For example, the calendar embedding can be defined as given in Equation 1. In some embodiments, conditioning embedder 417 concatenates multiple harmonics (e.g., k=1, . . . ,8) to form the full embedding vector included in conditioning embeddings 503, which captures seasonal and diurnal cycles. In some embodiments, conditioning embedder 417 embeds SST fields using convolutional encoders. In some embodiments, conditioning embedder 417 further applies a learned positional embedding to each pixel of the spherical grid, initialized with random values and optimized during training, to allow coarse diffusion model 423 to represent non-stationary climatological structures. The resulting conditioning embeddings 503 are concatenated or projected into a latent space that aligns with the inputs of coarse diffusion model 423.

At step 1003, masking module 415 generates masked climate data 501 based on climate data 511 and mask data 512. In some embodiments, masking module 415 applies channel masks included in mask data 512 to zero out or otherwise replace values for at least one of unobserved, unknown, or undetermined atmospheric variables included in climate data 511 while preserving values for observed variables. In some embodiments, masking module 415 uses spatial masks included in mask data 512 to restrict visibility to specified regions of a spherical grid, such as a HEALPix or HPX grid, which permits training on partial climate data or guidance by region-specific inputs.

At step 1004, noise adder 414 adds noise to masked climate data 501 to generate noisy masked climate data 502 based on masked climate data 501. In some embodiments, the noise scheduler included in noise adder 414 implements a log-uniform distribution across a range of variances [σₘᵢₙ, σₘₐₓ], where σₘᵢₙ is chosen large enough to mask strong climatological signals included in masked climate data 501, such as seasonal or diurnal cycles, and σₘₐₓ is chosen to permit sufficient variance coverage for all channels on the spherical grid. For example, the bounds can be determined by the conditions described in Equation 3. In some embodiments, σₘᵢₙ is selected via power-spectral analysis of atmospheric observables, while σₘₐₓ is selected based on the dimensionality of the grid so that

$${σ}_{max}^{2} ≳ n ,$$

where n is the number of pixels times channels. In some embodiments, to train diffusion models, such as coarse diffusion model 423, on the sphere, noise adder 414 draws a per-pixel noise independently as ∈ᵢ~ [symbol] (0,1) for every pixel index i with 1≤i≤12· [symbol] , where [symbol] is the HEALPix level with N_{side}= [symbol] and Nₚᵢₓ=12,

$${N}_{s i d e}^{2} = 12 \cdot {4}^{ℓ} .$$

In some examples, specific numerical values are used for the bounds of the noise scheduler, such as σₘᵢₙ=0.02 and σₘₐₓ=200, which span the dynamic range of the atmospheric variables included in climate data 511.

At step 1005, coarse diffusion model 423 performs a denoising step to generate predicted masked climate data 504 based on conditioning embeddings 503 and noisy masked climate data 502. In some embodiments, coarse diffusion model 423 includes a denoising network, such as a U-Net with spherical convolutional layers, residual connections, and cross-attention modules, that iteratively predicts cleaner climate states included in predicted masked climate data 504 from noisy masked climate data 502 at each denoising step. In some embodiments, coarse diffusion model 423 is trained using a score-based diffusion framework, in which the forward process gradually corrupts masked climate data with Gaussian-distributed noise, and the reverse process learns to denoise and recover the original atmospheric state included in masked climate data 501. In some examples, the forward process is defined as given in Equation 4. In some embodiments, coarse diffusion model 423 includes a denoising network (e.g., denoising function) [symbol] (·;σ) that approximates a score function, such as

$${∇}_{x} log p ( x ; σ ) \approx \frac{{𝒟}_{θ} ( x ; σ ) - x}{{σ}^{2}} .$$

model 423 employs an EDM sampler, which integrates the reverse-time ordinary differential equation given in Equation 5. In some examples, coarse diffusion model 423 generates predicted masked climate data 504 as described in Equation 6.

At step 1006, loss calculator 416 calculates loss 505 based on mask data 512, predicted masked climate data 504, and masked climate data 501. In some embodiments, loss 505 includes a reconstruction loss that is normalized by the observed fraction of variables indicated by the channel masks included in mask data 512, permitting that loss 505 is only applied to observed values and not to missing variables. In some examples, loss calculator 416 calculates loss 505 as described in Equation 7. In some embodiments, loss calculator 416 includes additional weighting terms so that atmospheric channels with fewer available observations contribute equally to the training objective, enabling coarse diffusion model 423 to learn a balanced representation across heterogeneous datasets.

At step 1007, model trainer 413 updates parameters of coarse diffusion model 423 based on loss 505. In some embodiments, model trainer 413 updates the parameters using a gradient-based optimizer, such as Adam, with fixed learning rate. In some embodiments, model trainer 413 uses the order of millions of examples from training data 422, such as approximately 9,856,000 samples, with a fixed batch size, such as 64 corresponding to roughly 3 million images or 256 corresponding to roughly 10 million images.

At step 1008, model trainer 413 determines whether to continue training. In some embodiments, training proceeds until a stopping criterion is met. The stopping criterion includes, without limitation, reaching a maximum number of training epochs, such as 250, observing convergence of a validation loss below a predefined threshold, or detecting no improvement in validation performance for a fixed number of epochs, such as 10 epochs, to prevent overfitting. In some embodiments, model trainer 413 uses early stopping to terminate training when validation loss plateaus, while model trainer 413 uses checkpointing to ensure that the best-performing version of coarse diffusion model 423 is retained for inference. When model trainer 413 determines to continue training, step 902 returns to step 1001. When model trainer 413 determines not to continue training, method 900 proceeds to step 903.

FIG. 11 is a flow diagram of method steps for training video diffusion model 424, according to various embodiments. Although the method steps are described in conjunction with the systems of FIGS. 1-8, persons skilled in the art will understand that any system configured to perform the method steps in any order falls within the scope of the present embodiments.

As shown, step 903 begins with step 1101, where conditioning embedder 417 receives conditioning data 510 and temporal masking module 419 receives climate data 511 and mask data 512. In some embodiments, conditioning data 510, climate data 511, and mask data 512 are included in training data 422.

At step 1102, conditioning embedder 417 generates conditioning embeddings 604 based on conditioning data 510. In some embodiments, conditioning embedder 417 transforms conditioning data 510 into one or more embedding vectors (e.g., conditioning embeddings 604) using neural encoders, lookup tables, positional encoding functions, and/or the like. In some embodiments, conditioning embedder 417 embeds calendar information included in conditioning data 510 using sinusoidal functions of DOY and time-of-day (t) that respect annual and diurnal periodicity. For example, the calendar embedding can be defined as given in Equation 1. In some embodiments, conditioning embedder 417 concatenates multiple harmonics (e.g., k=1, . . . ,8) to form the full embedding vector included in conditioning embeddings 604, which captures seasonal and diurnal cycles. In some embodiments, conditioning embedder 417 embeds SST fields using convolutional encoders. In some embodiments, conditioning embedder 417 further applies a learned positional embedding to each pixel of the spherical grid, initialized with random values and optimized during training, to allow video diffusion model 424 to represent non-stationary climatological structures. The resulting conditioning embeddings 604 are concatenated or projected into a latent space that aligns with the inputs of video diffusion model 424.

At step 1103, temporal masking module 419 generates temporal masked climate data 602, temporal mask 601, and channel and temporal masks 601 based on mask data 512 and climate data 511. In some embodiments, temporal masking module 419 applies temporal masks included in mask data 512 to designate which frames in a sequence of climate data 511 are visible for video diffusion model 424 during training. In some embodiments, temporal masking module 419 further combines temporal masks with channel masks included in mask data 512 to generate channel and temporal masks 601, allowing video diffusion model 424 to simulate scenarios where certain variables are missing for specific time steps. In some embodiments, temporal masking module 419 implements masked-conditioning strategies inspired by MCVD. During training of video diffusion model 424, temporal masking module 419 samples mask patterns m∈{0,1}^{T}, from a categorical distribution pₘₐₛₖ that blends several tasks, which include at least one of Bernoulli random frame dropout, masking all but the first or last few frames contiguously, masking middle frames while keeping endpoints visible, or full sequence masking. In some embodiments, the masked sequence included in temporal masked climate data 602 and the binary mask indicator included in channel and temporal masks 601 are concatenated channel-wise with other conditioning inputs included in conditioning embeddings 604.

At step 1104, noise adder 414 adds noise to masked temporal masked climate data 602 to generate noisy temporal masked climate data 603. In some embodiments, the noise scheduler included in noise adder 414 implements a log-uniform distribution across a range of variances [σₘᵢₙ, σₘₐₓ], where σₘᵢₙ is chosen large enough to mask strong climatological signals included in temporal masked climate data 602 and σₘₐₓ is chosen to permit sufficient variance coverage for all channels on the spherical grid. For example, the bounds can be determined by the conditions described in Equation 3. In some embodiments, to train diffusion models, such as video diffusion model 424, on the sphere, noise adder 414 draws a per-pixel noise independently as ∈ᵢ~ [symbol] (0,1) for every pixel index i with 1≤i≤12· [symbol] . In some examples, specific numerical values are used for the bounds of the noise scheduler, such as σₘᵢₙ=0.02 and σₘₐₓ ∈[200, 1000], which span the dynamic range of the atmospheric variables included in climate data 511.

At step 1105, video diffusion model 424 performs a denoising step to generate predicted temporal masked climate data 605 based on conditioning embeddings 604, temporal mask 607, and noisy temporal masked climate data 603. In some embodiments, video diffusion model 424 is configured to process short sequences of noisy temporal masked climate data 603. In some embodiments, video diffusion model 424 adds relative time embeddings to the inputs to represent temporal offsets, while per-frame calendar and SST conditioning included in conditioning embeddings 604 provide context for seasonal and interannual variability.

At step 1106, loss calculator 416 calculates loss 606 based on channel and temporal masks 601, predicted temporal masked climate data 605, and temporal masked climate data 602. In some embodiments, loss 606 includes a reconstruction loss that is normalized by the observed fraction of variables and timesteps indicated by channel and temporal masks 601, permitting that loss 606 is only applied to observed variables and visible frames rather than missing variables or masked timesteps. In some examples, loss calculator 416 calculates loss 606 as described in Equation 8. In some embodiments, loss calculator 416 includes additional weighting terms so that variables with fewer temporal observations or shorter time coverage contribute equally to the training objective, enabling video diffusion model 424 to learn balanced spatiotemporal representations across heterogeneous datasets.

At step 1107, model trainer 413 update parameters of video diffusion model 424 based on loss 606. In some embodiments, model trainer 413 updates the parameters using a gradient-based optimizer, such Adam, with a fixed learning rate. In some embodiments, model trainer 413 uses on the order of millions of examples from training data 422, such as approximately 2,160,000 video samples, with a fixed batch size.

At step 1108, model trainer 413 determines whether to continue training. In some embodiments, training proceeds until a stopping criterion is met. The stopping criterion includes, without limitation, reaching a maximum number of training epochs, such as 250, observing convergence of a validation loss below a predefined threshold, or detecting no improvement in validation performance for a fixed number of epochs, such as 10 epochs, to prevent overfitting. In some embodiments, model trainer 413 uses early stopping to terminate training when validation loss plateaus, while model trainer 413 uses checkpointing to ensure that the best-performing version of video diffusion model 424 is retained for inference. When model trainer 413 determines to continue training, step 903 returns to step 1101. When model trainer 413 determines not to continue training, method 900 proceeds to step 904.

FIG. 12 is a flow diagram of method steps for training super-resolution diffusion model 425, according to various embodiments. Although the method steps are described in conjunction with the systems of FIGS. 1-8, persons skilled in the art will understand that any system configured to perform the method steps in any order falls within the scope of the present embodiments.

As shown, step 904 begins with step 1201, where conditioning embedder 417 receives coarse climate data 710 and patching module 418 receives high-resolution climate data 711. In some embodiments, coarse climate data 710 is included in conditioning data 510 and high-resolution climate data 711 is included in training data 422.

At step 1202, patching module 418 generates patch identifiers 701 and patched high-resolution climate data 702 based on high-resolution climate data 711. In some embodiments, patching module 418 divides global high-resolution climate fields included in high-resolution climate data 711, represented on a spherical grid, such as HEALPix or HPX grid, into overlapping local patches of fixed size, for example 128×128 pixels at HPX1024 resolution. In some examples, coarse climate data 710 with resolution HPX64 can be re-gridded bilinearly to the HPX1024 128×128 patch and interpolated onto a lat-lon grid of resolution (128×128). In some embodiments, patched high-resolution climate data 702 includes overlapping patches to permit continuity between adjacent regions and to enable overlap-weighted stitching during inference using super-resolution diffusion model 425. In some examples, patching module 418 can process tens of millions of patches (e.g., on the order of 191 million patches derived from ~95,520 ICON samples) with batching strategies, such as a batch size of 960 to ensure tractable optimization at scale. In some embodiments, patching module 418 further samples patches stochastically during training of super-resolution diffusion model 425 to increase data diversity and reduce memory requirements.

At step 1203, conditioning embedder 417 generates conditioning embeddings 704 based on conditioning data 510 and patch identifiers 701. In some embodiments, conditioning embedder 417 incorporates patch identifiers 701 to encode the spatial location of patched high-resolution climate data 702 within the global HEALPix grid included in coarse climate data 710. In some embodiments, to cope with non-stationary spatial features, conditioning embedder 417 introduces learnable positional embeddings defined on the HPX1024 grid, which can be initialized using sinusoidal functions and optimized during training. The positional embeddings are concatenated with global positional embeddings of the lat-lon grid corresponding to each patch, thereby linking patch-local coordinates to the global spherical structure. In some embodiments, conditioning embedder 417 transforms patch identifiers 701 into positional indices or embeddings that disambiguate overlapping patches and preserve global spatial coherence. In some embodiments, conditioning embedder 417 concatenates or fuses the patch identifier embeddings with embeddings derived from conditioning data 510, such as coarse climate data 710, calendar information, or sea surface temperature fields, to provide spatially localized conditioning context.

At step 1204, noise adder 414 adds noise to patched high-resolution climate data 702 to generate noisy patched high-resolution climate data 703. In some embodiments, for training super-resolution diffusion model 425, the noise scheduler included in noise adder 414 uses a lognormal distribution of noise levels, parameterized by a mean Pₘₑₐₙ and standard deviation P_{std} in log space. For example, the log-normal schedule can be specified with values such as Pₘₑₐₙ=−1.2 and P_{std}=1.2, which determine the distribution of noise magnitudes across denoising steps. In some embodiments, to train on the sphere, noise adder 414 draws per-pixel noise independently as ∈ᵢ~ [symbol] (0,1) for every pixel index i with 1≤i≤12·4^{l}, where/is the HEALPix level, N_{side}=2^{l}, and

$${N}_{p i x} = 12 \cdot {N}_{s i d e}^{2} .$$

At step 1205, super-resolution diffusion model 425 performs a denoising step to generate predicted patched high-resolution climate data 705 based on conditioning embeddings 704 and noisy patched high-resolution climate data 703. In some embodiments, super-resolution diffusion model 425 replaces a conventional global denoiser with an aggregated local denoiser that operates patch-by-patch across the global feature map included in conditioning embeddings 704, denoising overlapping regions in a sliding-window fashion and then reassembling the results to reconstruct the global state included in predicted patched high-resolution climate data 705. In some examples, the global denoiser can be represented as an aggregation of local denoisers as described in Equation 9. In some embodiments, the aggregation also operates according to Equation 10. In some embodiments, super-resolution diffusion model 425 performs localized patch denoising under conditioning embeddings 704, while the aggregation equations, such as Equations 9 and 10, ensure that the denoised patches, are recombined into globally consistent predicted patched high-resolution climate data 705.

At step 1206, loss calculator 416 calculates loss 706 based on patched high-resolution climate data 702 and predicted patched high-resolution climate data 705. In some embodiments, loss 706 is defined as a denoising score matching objective applied at the patch level. In some examples, given training samples x~p_{data}, conditioning embeddings 704 y, noise ∈~ [symbol] (0,σ²I), and a patch sampling operator [symbol] that extracts a local patch, loss 706 can be described by Equation 11. In some embodiments, loss 706 is averaged over all patches and normalized to prevent bias toward regions with denser coverage. In some embodiments, loss 706 includes a patch-based reconstruction loss, optionally combined with a patch overlap consistency loss to permit continuity between adjacent patches. In some embodiments, loss calculator 416 also includes perceptual losses, photometric consistency losses, and/or diffusion-specific denoising losses in the generated loss 706, depending on the training objective.

At step 1207, model trainer 413 update parameters of super-resolution diffusion model 425 based on loss 706. In some embodiments, model trainer 413 updates the parameters using a gradient-based optimizer, such as SGD, with a fixed learning rate. In some embodiments, model trainer 413 uses tens of thousands of global samples from training data 422, such as approximately 95,520 ICON samples corresponding to about 191 million 128×128 patches cropped from HPX1024 fields, with a fixed batch size, such as 960.

At step 1208, model trainer 413 determines whether to continue training. In some embodiments, training proceeds until a stopping criterion is met. The stopping criterion includes, without limitation, reaching a maximum number of training epochs, such as 250, observing convergence of a validation loss below a predefined threshold, or detecting no improvement in validation performance for a fixed number of epochs, such as ten epochs, to prevent overfitting. In some embodiments, model trainer 413 uses early stopping to terminate training when validation loss plateaus, while model trainer 413 uses checkpointing to ensure that the best-performing version of super-resolution diffusion model 425 is retained for inference. When model trainer 413 determines to continue training, step 904 returns to step 1201. When model trainer 413 determines not to continue training, method 900 terminates.

FIG. 13 is a flow diagram of method steps for generating output climate data 460, according to various embodiments. Although the method steps are described in conjunction with the systems of FIGS. 1-8, persons skilled in the art will understand that any system configured to perform the method steps in any order falls within the scope of the present embodiments.

As shown, a method 1300 begins with step 1301, wherein climate emulation application 446 receives user control input 801, input climate data 802, input conditioning data 803, input mask data 804, and input patch data 805. In some embodiments, user control input 801, input climate data 802, input conditioning data 803, input mask data 804, and input patch data 805 are received via one or more I/O devices.

At step 1302, climate emulation application 446 selects an inference strategy based on user control input 801. In some embodiments, climate emulation application 446 uses user control input 801 to determine the type of climate task to be performed, and climate emulation application 446 invokes one or more of coarse diffusion model 423, video diffusion model 424, or super-resolution diffusion model 425, accordingly. Climate emulation application 446 flexibly adapts the inference pipeline based on the selected inference strategy to meet user-specified objectives and produces output climate data 460 consistent with the selected application.

At step 1303, multi-diffusion inference module 449 performs one or more reverse diffusion steps, using at least one of coarse diffusion model 423, video diffusion model 424, or super-resolution diffusion model 425, to generate output climate data 460 based on inference strategy, input climate data 802, input conditioning data 803, input mask data 804, and optionally input patch data 805. In some embodiments, when the inference strategy corresponds to climate emulation, multi-diffusion inference module 449 applies at least one of coarse diffusion model 423, video diffusion model 424, or super-resolution diffusion model 425 to process input climate data 802 and input conditioning data 803 and reconstruct global climate states included in output climate data 460. When the inference strategy corresponds to channel in-filling, multi-diffusion inference module 449 applies super-resolution diffusion model 425 to process input climate data 802, input conditioning data 803, and input mask data 804 and reconstruct missing channels or timesteps included in output climate data 460. When the inference strategy corresponds to bias correction, multi-diffusion inference module 449 applies at least one of coarse diffusion model 423 or video diffusion model 424, to adjust systematic deviations in input climate data 802 relative to reference climatology included in input conditioning data 803. When the inference strategy corresponds to downscaling, multi-diffusion inference module 449 applies super-resolution diffusion model 425 to process input climate data 802, input conditioning data 803, and input patch data 805 and generate high-resolution output climate data 460 from coarse-resolution inputs. When the inference strategy corresponds to what-if scenario analysis, multi-diffusion inference module 449 applies at least one of coarse diffusion model 423, video diffusion model 424, or super-resolution diffusion model 425 to simulate counterfactual climate states based on input conditioning data 803, such as modified sea surface temperature fields, altered greenhouse gas concentrations, and/or the like. When the inference strategy corresponds to steerable sampling, multi-diffusion inference module 449 applies at least one of coarse diffusion model 423, video diffusion model 424, or super-resolution diffusion model 425 while clamping or conditioning selected values of input climate data 802 or input conditioning data 803 during reverse diffusion steps, to guide output climate data 460 toward user-specified spatial attributes, such as regional masks, thresholds, or climatological indices.

In sum, techniques are disclosed for climate emulation using diffusion models. The disclosed techniques include a coarse diffusion model, a video diffusion model, and a super-resolution diffusion model. The coarse diffusion model is a machine learning model, such as a neural network, which processes one or more first conditioning embeddings and generates predicted masked climate data. The video diffusion model is another machine learning model, such as neural network, which processes the first conditioning embeddings and a temporal mask and generates predicted temporal masked climate data. The super-resolution diffusion model is yet another machine learning model, such as a neural network, which processes one or more second conditional embeddings and generates predicted patched high-resolution climate data.

In some embodiments, during training of the coarse diffusion model, a conditioning embedder processes conditioning data included in the training data and generates the first conditioning embeddings. A masking module processes climate data and mask data included in the training data and generates masked climate data. A noise adder adds noise to the masked climate data to generate noisy masked climate data. The coarse diffusion model performs a denoising step to generate the predicted masked climate data based on the first conditioning embeddings and the noisy masked climate data. A loss calculator calculates a first loss based on the predicted masked climate data, the masked climate data, and the mask data. The model trainer updates the one or more parameters of the coarse diffusion model based on the first loss.

In some embodiments, during the training of the video diffusion model, the conditioning embedder processes the conditioning data and generates the first conditioning embedding. A temporal masking module processes the mask data and the climate data and generates temporal masked climate data, a temporal mask, and one or more channel and temporal masks. The noise adder adds noise to the temporal masked climate data and generates noisy temporal masked climate data. The video diffusion model performs a denoising diffusion step to generate predicted temporal masked climate data based on the first conditioning embeddings, the temporal mask, and the noisy temporal masked climate data. The loss calculator calculates a second loss based on predicted temporal masked climate data, the temporal masked climate data, and the channel and temporal masks. The model trainer updates the parameters of the video diffusion model based on the second loss.

In some embodiments, during the training of the super-resolution diffusion model, a patching module processes high-resolution climate data included in the training data and generates one or more patch identifiers and patched high-resolution climate data. The conditioning embedder processes the patch identifiers and coarse climate data included in the conditioning data and generates the second conditioning embeddings. The noise adder adds noise to the patched high-resolution climate data and generates noisy patched high-resolution climate data. The super-resolution diffusion model performs a denoising step to generate predicted patched high-resolution climate data based on the second conditioning embeddings and the noisy patched high-resolution climate data. The loss calculator calculates a third loss based on the patched high-resolution climate data and the predicted patched high-resolution climate data. The model trainer updates the one or more parameters of super-resolution diffusion model based on the third loss.

In some embodiments, once training is complete, a climate emulation application uses the trained coarse diffusion model, the trained video diffusion model, and the trained super-resolution model to process a user control input, input climate data, input conditioning data, input mask data and optionally input patch data and generate output climate data. The climate emulation application selects an inference strategy based on the user control input. In some embodiments, the climate emulation application includes a multi-diffusion inference module that performs one or more reverse diffusion steps, using at least one of the trained coarse diffusion model, the trained video diffusion model, and the trained super-resolution model, to generate the output climate data based on the inference strategy, the input climate data, the input conditioning data, the input mask data and optionally the input patch data.

At least one technical advantage of the disclosed techniques relative to the prior art is that the disclosed techniques eliminate the need for computationally intensive numerical solvers and parameterized sub-grid process approximations by directly learning from observational and simulation data, thereby enabling kilometer-scale global field generation with significantly reduced computational cost and runtime. Another technical advantage is that the disclosed techniques relax rigid discretization schemes and stability-constrained integration steps, which allow the models to adapt to diverse climate regimes without manual calibration or tuning. A further technical advantage is that the disclosed techniques support heterogeneous and incomplete datasets, permitting the incorporation of non-aligned grids, partially missing channels, or sparsely sampled records into a single generative model without requiring exhaustive preprocessing or harmonization. These technical advantages provide one or more technological improvements over prior art approaches.

The following clauses describe aspects of the various embodiments.

1. In some embodiments, a computer-implemented method for training a diffusion model includes generating, based on conditioning data, one or more conditioning embeddings, generating, based on climate data and mask data, temporal masked climate data, a temporal mask, and one or more channel and temporal masks, adding noise to the temporal masked climate data to generate noisy temporal masked climate data, performing, using the diffusion model, a denoising operation to generate predicted temporal masked climate data based on the one or more conditioning embeddings, the noisy temporal masked climate data, and the temporal mask, calculating a loss based on the one or more channel and temporal masks, the temporal masked climate data, and the predicted temporal masked climate data, and updating, based on the loss, one or more parameters of the diffusion model.

2. The computer-implemented method of clause 1, where generating the temporal masked climate data, the temporal mask, and the one or more channel and temporal masks includes implementing a masked conditional video diffusion conditioning strategy.

3. The computer-implemented method of clauses 1 or 2, where generating the temporal masked climate data, the temporal mask, and the one or more channel and temporal masks includes sampling one or more mask patterns from a categorical distribution that blends one or more tasks.

4. The computer-implemented method of any of clauses 1-3, where the one or more tasks include at least one of Bernoulli random frame dropout, masking at least one of a first frame or one or more last frames contiguously, masking one or more middle frames and keeping one or more endpoints visible, or full sequence masking.

5. The computer-implemented method of any of clauses 1-4, where generating the temporal masked climate data, the temporal mask, and the one or more channel and temporal masks includes concatenating a masked sequence included in the temporal masked climate data and a binary mask indicator included in the one or more channel and temporal masks.

6. The computer-implemented method of any of clauses 1-5, where the loss includes a reconstruction loss that is normalized by an observed fraction of one or more variables and one or more timesteps.

7. The computer-implemented method of any of clauses 1-6, where calculating the loss includes normalizing the loss by a mean of one or more channel and temporal mask values included in the one or more channel and temporal masks.

8. The computer-implemented method of any of clauses 1-7, where the diffusion model includes a U-Net backbone that includes one or more spherical convolutional layers interleaved with one or more temporal self-attention layers.

9. The computer-implemented method of any of clauses 1-8, where performing the denoising operation to generate the predicted temporal masked climate data includes generating, based on one or more sequences included in the noisy temporal masked climate data and the temporal mask, the predicted temporal masked climate data.

10. The computer-implemented method of any of clauses 1-9, where the noise is generated according to a noise schedule including a log-uniform distribution of a range one or more variances.

11. The computer-implemented method of any of clauses 1-10, where the range of the one or more variances includes a lower variance bound to mask one or more climatological signals included in the temporal masked climate data, and an upper variance bound to permit a variance coverage for one or more channels included in a spherical grid.

12. The computer-implemented method of any of clauses 1-11, where performing the denoising operation to generate predicted temporal masked climate data includes adding one or more relative time embeddings to one or more inputs.

13. The computer-implemented method of any of clauses 1-12, further including receiving a user control input, input climate data, input conditioning data, and input patch data, generating, an inference strategy, based on the user control input, and performing, using the diffusion model, one or more reverse diffusion operations to generate output climate data based on the input climate data, the input conditioning data, and the input patch data.

14. In some embodiments, one or more non-transitory computer-readable media store instructions that, when executed by one or more processors, cause the one or more processors to perform the steps of generating, based on conditioning data, one or more conditioning embeddings, generating, based on climate data and mask data, temporal masked climate data, a temporal mask, and one or more channel and temporal masks, adding noise to the temporal masked climate data to generate noisy temporal masked climate data, performing, using a diffusion model, a denoising operation to generate predicted temporal masked climate data based on the one or more conditioning embeddings, the noisy temporal masked climate data, and the temporal mask, calculating a loss based on the one or more channel and temporal masks, the temporal masked climate data, and the predicted temporal masked climate data, and updating, based on the loss, one or more parameters of the diffusion model.

15. The one or more non-transitory computer-readable media of clause 14, where generating the temporal masked climate data, the temporal mask, and the one or more channel and temporal masks includes implementing a masked conditional video diffusion conditioning strategy.

16. The one or more non-transitory computer-readable media of clauses 14 or 15, where generating the temporal masked climate data, the temporal mask, and the one or more channel and temporal masks includes sampling one or more mask patterns from a categorical distribution that blends one or more tasks.

17. The one or more non-transitory computer-readable media of any of clauses 14-16, where the one or more tasks include at least one of Bernoulli random frame dropout, masking at least one of a first frame or one or more last frames contiguously, masking one or more middle frames and keeping one or more endpoints visible, or full sequence masking.

18. The one or more non-transitory computer-readable media of any of clauses 14-17, where the diffusion model includes a U-Net backbone that includes one or more spherical convolutional layers interleaved with one or more temporal self-attention layers.

19. The one or more non-transitory computer-readable media of any of clauses 14-18, where performing the denoising operation to generate predicted temporal masked climate data includes adding one or more relative time embeddings to one or more inputs.

20. In some embodiments, a system includes one or more memories storing instructions, and one or more processors that are coupled to the one or more memories and, when executing the instructions, are configured to generate, based on conditioning data, one or more conditioning embeddings, generate, based on climate data and mask data, temporal masked climate data, a temporal mask, and one or more channel and temporal masks, add noise to the temporal masked climate data to generate noisy temporal masked climate data, perform, using a diffusion model, a denoising operation to generate predicted temporal masked climate data based on the one or more conditioning embeddings, the noisy temporal masked climate data, and the temporal mask, calculate a loss based on the one or more channel and temporal masks, the temporal masked climate data, and the predicted temporal masked climate data, and update, based on the loss, one or more parameters of the diffusion model.

Any and all combinations of any of the claim elements recited in any of the claims and/or any elements described in this application, in any fashion, fall within the contemplated scope of the present disclosure and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for training a diffusion model, the method comprising:
generating, based on conditioning data, one or more conditioning embeddings;
generating, based on climate data and mask data, temporal masked climate data, a temporal mask, and one or more channel and temporal masks;
adding noise to the temporal masked climate data to generate noisy temporal masked climate data;
performing, using the diffusion model, a denoising operation to generate predicted temporal masked climate data based on the one or more conditioning embeddings, the noisy temporal masked climate data, and the temporal mask;
calculating a loss based on the one or more channel and temporal masks, the temporal masked climate data, and the predicted temporal masked climate data; and
updating, based on the loss, one or more parameters of the diffusion model.

2. The computer-implemented method of claim 1, wherein generating the temporal masked climate data, the temporal mask, and the one or more channel and temporal masks comprises implementing a masked conditional video diffusion conditioning strategy.

3. The computer-implemented method of claim 1, wherein generating the temporal masked climate data, the temporal mask, and the one or more channel and temporal masks comprises sampling one or more mask patterns from a categorical distribution that blends one or more tasks.

4. The computer-implemented method of claim 3, wherein the one or more tasks comprise at least one of:
Bernoulli random frame dropout;
masking at least one of a first frame or one or more last frames contiguously;
masking one or more middle frames and keeping one or more endpoints visible; or
full sequence masking.

5. The computer-implemented method of claim 1, wherein generating the temporal masked climate data, the temporal mask, and the one or more channel and temporal masks comprises concatenating a masked sequence included in the temporal masked climate data and a binary mask indicator included in the one or more channel and temporal masks.

6. The computer-implemented method of claim 1, wherein the loss comprises a reconstruction loss that is normalized by an observed fraction of one or more variables and one or more timesteps.

7. The computer-implemented method of claim 1, wherein calculating the loss comprises normalizing the loss by a mean of one or more channel and temporal mask values included in the one or more channel and temporal masks.

8. The computer-implemented method of claim 1, wherein the diffusion model comprises a U-Net backbone that includes one or more spherical convolutional layers interleaved with one or more temporal self-attention layers.

9. The computer-implemented method of claim 1, wherein performing the denoising operation to generate the predicted temporal masked climate data comprises generating, based on one or more sequences included in the noisy temporal masked climate data and the temporal mask, the predicted temporal masked climate data.

10. The computer-implemented method of claim 1, wherein the noise is generated according to a noise schedule comprising a log-uniform distribution of a range one or more variances.

11. The computer-implemented method of claim 10, wherein the range of the one or more variances comprises:
a lower variance bound to mask one or more climatological signals included in the temporal masked climate data; and
an upper variance bound to permit a variance coverage for one or more channels included in a spherical grid.

12. The computer-implemented method of claim 1, wherein performing the denoising operation to generate predicted temporal masked climate data comprises adding one or more relative time embeddings to one or more inputs.

13. The computer-implemented method of claim 1, further comprising receiving a user control input, input climate data, input conditioning data, and input patch data;
generating, an inference strategy, based on the user control input; and
performing, using the diffusion model, one or more reverse diffusion operations to generate output climate data based on the input climate data, the input conditioning data, and the input patch data.

14. One or more non-transitory computer-readable media storing instructions that, when executed by one or more processors, cause the one or more processors to perform the steps of:
generating, based on conditioning data, one or more conditioning embeddings;
generating, based on climate data and mask data, temporal masked climate data, a temporal mask, and one or more channel and temporal masks;
adding noise to the temporal masked climate data to generate noisy temporal masked climate data;
performing, using a diffusion model, a denoising operation to generate predicted temporal masked climate data based on the one or more conditioning embeddings, the noisy temporal masked climate data, and the temporal mask;
calculating a loss based on the one or more channel and temporal masks, the temporal masked climate data, and the predicted temporal masked climate data; and
updating, based on the loss, one or more parameters of the diffusion model.

15. The one or more non-transitory computer-readable media of claim 14, wherein generating the temporal masked climate data, the temporal mask, and the one or more channel and temporal masks comprises implementing a masked conditional video diffusion conditioning strategy.

16. The one or more non-transitory computer-readable media of claim 14, wherein generating the temporal masked climate data, the temporal mask, and the one or more channel and temporal masks comprises sampling one or more mask patterns from a categorical distribution that blends one or more tasks.

17. The one or more non-transitory computer-readable media of claim 16, wherein the one or more tasks comprise at least one of:
Bernoulli random frame dropout;
masking at least one of a first frame or one or more last frames contiguously;
masking one or more middle frames and keeping one or more endpoints visible; or
full sequence masking.

18. The one or more non-transitory computer-readable media of claim 14, wherein the diffusion model comprises a U-Net backbone that includes one or more spherical convolutional layers interleaved with one or more temporal self-attention layers.

19. The one or more non-transitory computer-readable media of claim 14, wherein performing the denoising operation to generate predicted temporal masked climate data comprises adding one or more relative time embeddings to one or more inputs.

20. A system, comprising:
one or more memories storing instructions, and
one or more processors that are coupled to the one or more memories and, when executing the instructions, are configured to:
generate, based on conditioning data, one or more conditioning embeddings,
generate, based on climate data and mask data, temporal masked climate data, a temporal mask, and one or more channel and temporal masks,
add noise to the temporal masked climate data to generate noisy temporal masked climate data,
perform, using a diffusion model, a denoising operation to generate predicted temporal masked climate data based on the one or more conditioning embeddings, the noisy temporal masked climate data, and the temporal mask,
calculate a loss based on the one or more channel and temporal masks, the temporal masked climate data, and the predicted temporal masked climate data, and
update, based on the loss, one or more parameters of the diffusion model.
